(19) United States
(12) Patent Application Publication
(10) Pub. No.: US 2013/0002696 A1
(43) Pub. Date: Jan. 3, 2013

(54) Computer Based Models of Printed Material

(76) Inventors: Andrew James Sauer, Cincinnati, OH (US); Michael Dale Trennepohl, Cincinnati, OH (US); David Rex Price, Indianapolis, IN (US)

(21) Appl. No.: 13/175,810

(22) Filed: Jul. 1, 2011

(51) Int. Cl. G06T 11/40

(52) U.S. Cl. 345/582

(57) ABSTRACT

Computer based models for printed materials.

### FIELD

In general, embodiments of the present disclosure relate to computer based models for printed materials. In particular, embodiments of the present disclosure relate to computer based models for simulating the appearance of materials printed with artwork images.

### BACKGROUND

Many manufactured articles include materials that are printed with artwork images. For example, a disposable diaper can be printed with an artwork image. However, it can be difficult to predict how a particular artwork image will appear when it is printed on a particular material.

### SUMMARY

However, embodiments of the present disclosure can at least assist in predicting how a particular artwork image will appear when it is printed on a particular material. The present disclosure includes methods of representing an artwork image with a computer based model of the artwork image. In particular, the present disclosure includes computer based methods for simulating the appearance of materials printed with artwork images. As a result, materials that are printed with artwork images can be evaluated and modified as computer based models before they are printed in the real world.

### BRIEF DESCRIPTION OF THE DRAWINGS

FIG. 1 is an illustration of an exemplary artwork image, printed on a material.

FIG. 2A is a front view of a layer of fibrous material, used in a printed material.

FIG. 2B is a side view of the layer of fibrous material of FIG. 2A.

FIG. 2C is a bottom view of the layer of fibrous material of FIG. 2A.

FIG. 2D is a front view of a layer of textured material, used in a printed material.

FIG. 2E is a side view of the layer of textured material of FIG. 2D.

FIG. 2F is a bottom view of the layer of textured material of FIG. 2D.

FIG. 2G is a front view of a layer of porous material, used in a printed material.

FIG. 2H is a side view of the layer of porous material of FIG. 2G.

FIG. 2I is a bottom view of the layer of porous material of FIG. 2G.

FIG. 3A is a front view of front fibers from the layer of fibrous material of FIG. 2A.

FIG. 3B is a front view of front open areas from the layer of fibrous material of FIG. 2A.

FIG. 4A is a front view of back fibers from the layer of fibrous material of FIG. 2A.

FIG. 4B is a front view of back open areas from the layer of fibrous material of FIG. 2A.

FIG. 5 is a front view of a layer of bonded material, used in a printed material.

FIG. 6A is a front view of the bond pattern of the bonded material of FIG. 5.

FIG. 6B is a front view of the unbonded area of the bonded material of FIG. 5.

FIG. 7 is a front view of a layer of bonded fibrous material, with the layer of fibrous material of FIG. 2A and the bond pattern of FIG. 6A.

FIG. 8 is a front view of a background material, used in a printed material.

FIG. 9A is a block diagram of a computer based model of a printed material, having the artwork image of FIG. 1 printed on the front surface of the layer of fibrous material of FIG. 2A, with the background material of FIG. 8 unprinted and disposed in back of the fibrous material.

FIG. 9B is an illustration of a front appearance of the printed material, as represented by the computer based model of FIG. 9A.

FIG. 9C is a block diagram of a computer based model of a printed material, having the artwork image of FIG. 1 printed on the front surface of the layer of textured material of FIG. 2D.

FIG. 9D is an illustration of a front appearance of the printed material, as represented by the computer based model of FIG. 9C.

FIG. 9E is a block diagram of a computer based model of a printed material, having the artwork image of FIG. 1 printed on the front surface of the layer of porous material of FIG. 2G, with the background material of FIG. 8 unprinted and disposed in back of the porous material.

FIG. 9F is an illustration of a front appearance of the printed material, as represented by the computer based model of FIG. 9E.

FIG. 10A is a block diagram of a computer based model of a printed material, having the artwork image of FIG. 1 printed on the back surface of the layer of fibrous material of FIG. 2A, with the background material of FIG. 8 unprinted and disposed in back of the fibrous material.

FIG. 10B is an illustration of a front appearance of the printed material, as represented by the computer based model of FIG. 10A.

FIG. 11A is a block diagram of a computer based model of a printed material, having the artwork image of FIG. 1 printed on the front surface of the background material of FIG. 8, with the background material disposed in back of the layer of fibrous material of FIG. 2A.

FIG. 11B is an illustration of a front appearance of the printed material, as displayed by the computer based model of FIG. 11A.

FIG. 11C is a block diagram of a computer based model of a printed material, having the artwork image of FIG. 1 printed on the front surface of the background material of FIG. 8, with the background material disposed in back of the layer of porous material of FIG. 2G.

FIG. 11D is an illustration of a front appearance of the printed material, as displayed by the computer based model of FIG. 11C.

FIG. 12A is a block diagram of a computer based model of a printed material, having the artwork image of FIG. 1 printed on the front surface of the background material of FIG. 8, with the background material disposed in back of the bonded material of FIG. 5.

FIG. 12B is an illustration of a front appearance of the printed material, as displayed by the computer based model of FIG. 12A.

FIG. 13A is a block diagram of a computer based model of a printed material, having the artwork image of FIG. 1 printed on the front surface of the layer of bonded fibrous material of FIG. 7, with the background material of FIG. 8 unprinted and disposed in back of the bonded fibrous material.

FIG. 13B is an illustration of a front appearance of the printed material, as displayed by the computer based model of FIG. 13A.

FIG. 14A is a block diagram of a computer based model of a printed material, having the artwork image of FIG. 1 printed on the back surface of the layer of bonded fibrous material of FIG. 7, with the background material of FIG. 8 unprinted and disposed in back of the bonded fibrous material.

FIG. 14B is an illustration of a front appearance of the printed material, as displayed by the computer based model of FIG. 14A.

FIG. 15A is a block diagram of a computer based model of a printed material, having the artwork image of FIG. 1 printed on the front surface of the background material of FIG. 8, with the background material disposed in back of the layer of bonded fibrous material of FIG. 7.

FIG. 15B is an illustration of a front appearance of the printed material, as displayed by the computer based model of FIG. 15A.

### DETAILED DESCRIPTION

Embodiments of the present disclosure can at least assist in predicting how a particular artwork image will appear when it is printed on a particular material. The present disclosure includes methods of representing an artwork image with a computer based model of the artwork image. In particular, the present disclosure includes computer based methods for simulating the appearance of materials printed with artwork images. As a result, materials that are printed with artwork images can be evaluated and modified as computer based models before they are printed in the real world.

Custom software, commercially available software, and/or freely available software can be used to represent and transform the computer based models described herein. Such software can be run on various computer hardware, such as a personal computer, a minicomputer, a cluster of computers, a mainframe, a supercomputer, or any other kind of machine on which such program instructions can execute. Examples of such software include Adobe Photoshop and Adobe Illustrator (by Adobe Systems Inc. of San Jose, Calif., United States), MATLAB (by Mathworks, Inc. of Natick, Mass., United States), the GNU Image Manipulation Program (by The GIMP Development Team, available at www.gimp.org), Autodesk Maya (by Autodesk, Inc., of San Rafael, Calif., United States).

Any and all of the methods of the present disclosure that use computer based models can be represented as program instructions for causing a device to perform a method, and such instructions can be stored on any form of computer readable medium known in the art. Such instructions can also be stored and used as part of a computer-based system.

As used herein, the following meanings apply. The term “fibrous material” is a structure of many fibers. The term “bonded material” refers to a material bonded with a bond pattern. The term “bond pattern” refers to a pattern of bond area imparted to a material. For any bonded material, the term “bond area” refers to a distinct location, on the material, at which the material has substantially modified physical properties, when compared with the material adjacent to the bond area (i.e. the one or more unbonded areas). As an example, for a bonded fibrous material, locations on the material, at which the fibers are bonded to be substantially more interconnected, when compared with the fibers of the adjacent area(s), are considered to be bond areas. As another example, for an embossed non-fibrous material, locations on the material, at which the material is embossed to be relatively thinner, when compared with the material of the adjacent non-embossed area(s), are considered to be bond areas.

The term “opacity” refers to the ability of a material to transmit light. A more opaque material has a relatively higher percent opacity and is relatively less able to transmit light. A less opaque material has a relatively lower percent opacity and is relatively more able to transmit light. A material that is fully opaque has an opacity of 100 percent is not able to transmit any light. As used herein, a material that is able to transmit light to only a very small degree (e.g. having an opacity of 80-99 percent, including any integer percent value in this range, and any range formed by any of these integer values) is considered to be substantially opaque. A material that is fully transparent has an opacity of zero percent and is able to transmit all light. As used herein, a material that is able to transmit light to a very large degree (e.g. having an opacity of 1-20 percent, including any integer percent value in this range, and any range formed by any of these integer values) is considered to be substantially transparent. Each of the computer based models of materials disclosed herein can be configured to represent the one or more opacities of the one or more materials being modeled, as described herein.

Throughout the present disclosure, various suffixes are used to designate different types of elements in the figures. Elements with the suffix -a designate real world objects. Elements with the suffix -b designate computer based models. Elements with the suffix -c designate representations from computer based models.

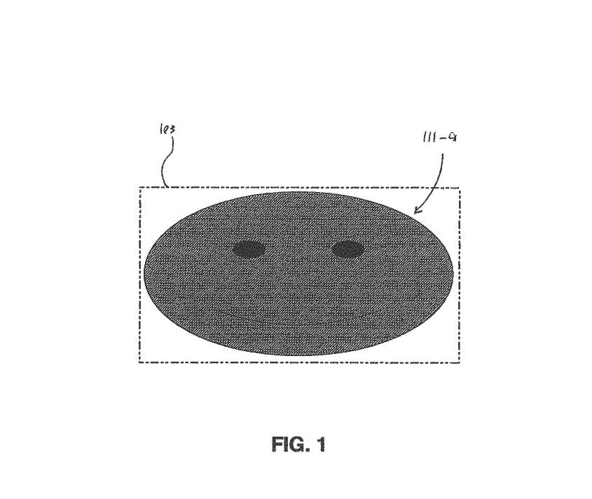

FIG. 1 is an illustration 111-a of an exemplary artwork image, printed within a rectangular reference area 103. The artwork image is a simple gray-scale drawing of a face. This artwork image is used for reference throughout the figures of the present disclosure. Program instructions can execute to represent the illustration 111-a of the artwork image with a computer based model of the artwork image. In various embodiments, the illustration 111-a of the artwork image can be created as a computer based model by drawing the image, scanning the image, or generating a model of the image with other program instructions. Similarly, program instructions can also execute to represent other artwork images with computer based models of those artwork images.

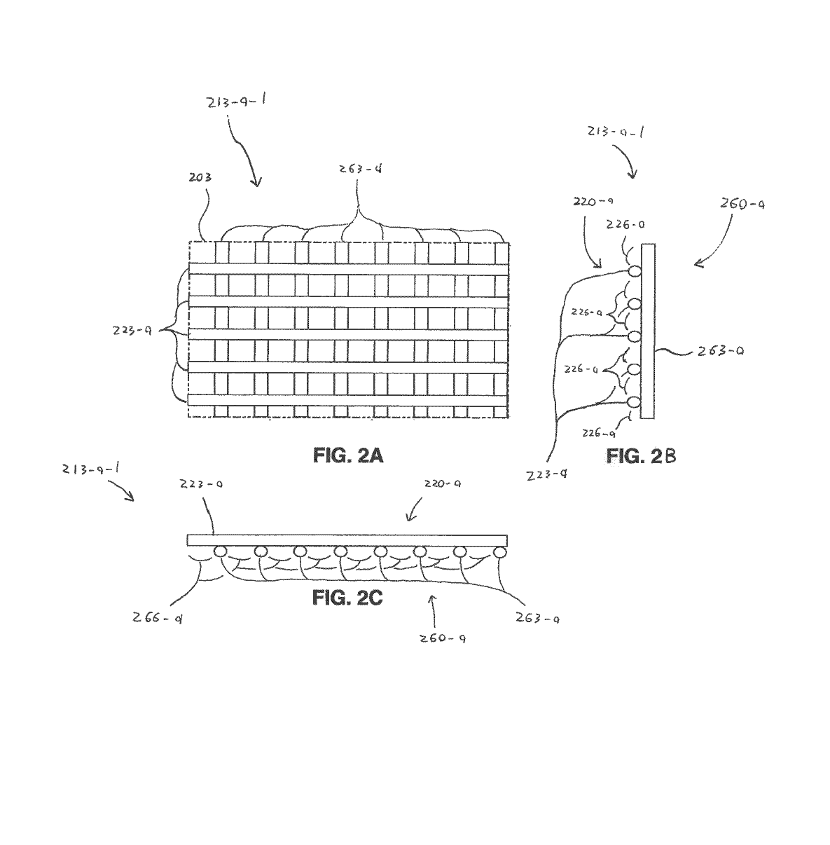

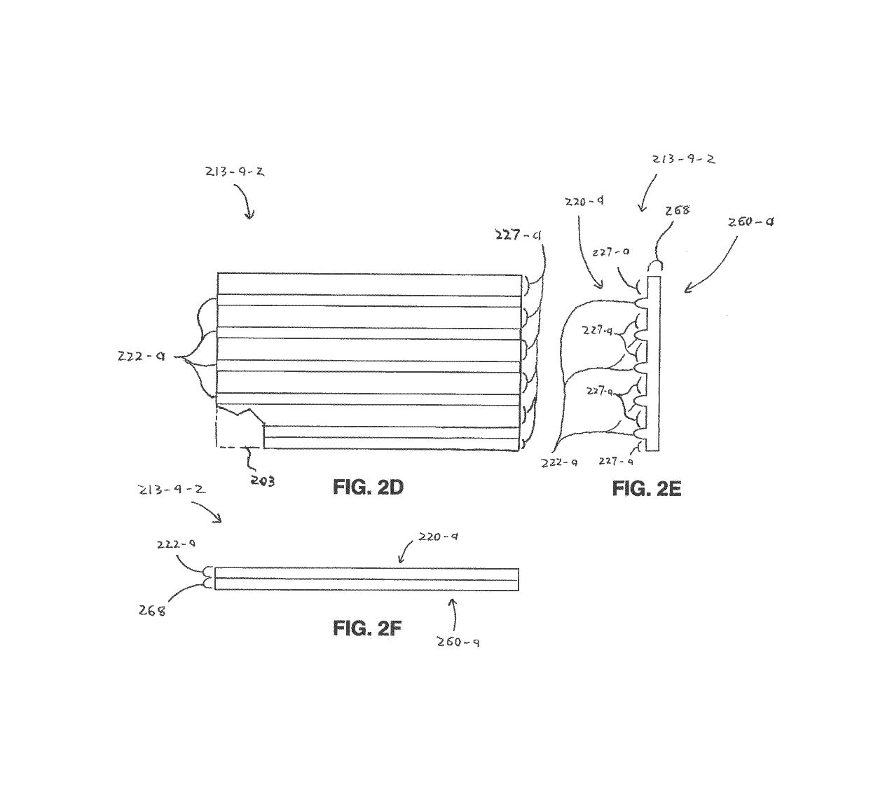

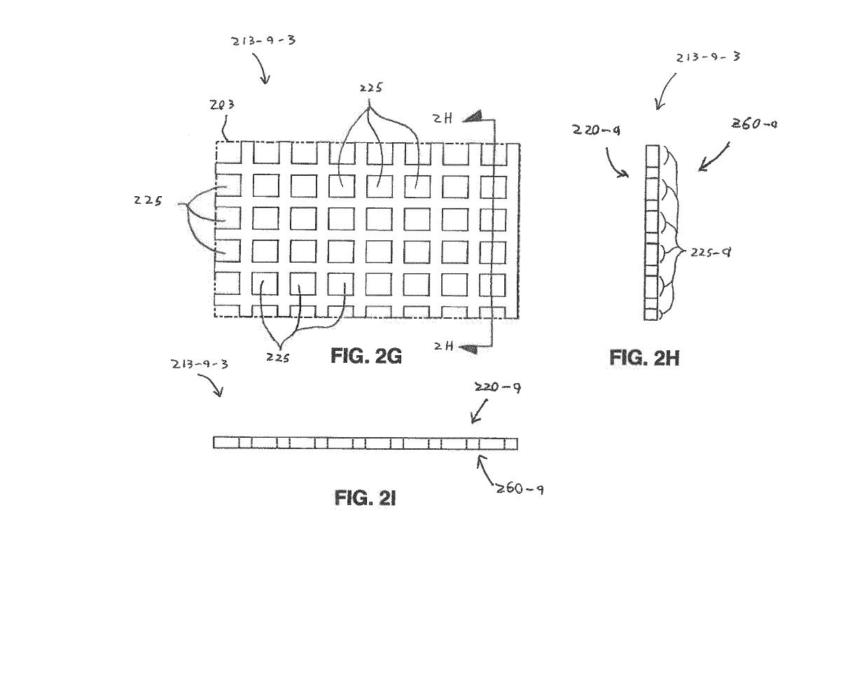

FIG. 2A is a front view of an exemplary layer of fibrous material 213-a-1, within a reference area 203. The layer of fibrous material 213-a-1 includes front fibers 223-a and back fibers 263-a. The reference area 203 is the same size and shape as the reference area 103. The layer of fibrous material 213-a-1 is used for reference throughout the figures of the present disclosure.

The front fibers 223-a are neither fully opaque nor fully transparent, but have a degree of opacity that provides a limited ability to transmit light. In various embodiments, the front fibers 223-a can have an opacity from 1-99%, including any integer percent value in this range, and any range formed by any of these integer values. In various embodiments, the front fibers 223-a can be substantially opaque or substantially transparent. In alternate embodiments, front fibers can be fully opaque or fully transparent. In the embodiment of FIG. 2A, all of the front fibers 223-a have the same degree of opacity, however in various alternate embodiments, front fibers can have varying degrees of opacity, and each of the front fibers can have any degree of opacity described herein.

The back fibers 263-a are neither fully opaque nor fully transparent, but have a degree of opacity that provides a limited ability to transmit light. In various embodiments, the back fibers 263-a can have an opacity from 1-99%, including any integer percent value in this range, and any range formed by any of these integer values. In various embodiments, the back fibers 263-a can be substantially opaque or substantially transparent. In alternate embodiments, back fibers can be fully opaque or fully transparent. In the embodiment of FIG. 2A, all of the back fibers 263-a have the same degree of opacity, however in various alternate embodiments, back fibers can have varying degrees of opacity, and each of the back fibers can have any degree of opacity described herein.

FIG. 2B is a side view of the layer of fibrous material 213-a-1 of FIG. 2A. The fibrous material 213-a-1 includes a front surface 220-a and a back surface 260-a. The front surface 220-a includes the front fibers 223-a and front open areas 226-a disposed between the front fibers 223-a. The back surface 260-a includes the back fibers 263-a.

FIG. 2C is a bottom view of the layer of fibrous material 213-a-1 of FIG. 2A. The fibrous material 213-a-1 includes a front surface 220-a and a back surface 260-a. The front surface 220-a includes the front fibers 223-a. The back surface 260-a includes the back fibers 263-a and back open areas 266-a disposed between the back fibers.

Program instructions can execute to represent the layer of fibrous material 213-a-1 with a computer based model of the layer of fibrous material. The model can be configured to represent the geometries of fibers and open areas in the layer of fibrous material. The model can also be configured to represent the physical properties of the fibrous material, including the opacities of the fibers. In various embodiments, the layer of fibrous material 213-a-1 can be created as a computer based model by drawing the material, scanning the material, or generating a model of the material image with other program instructions. For example, a computer based model of a layer of fibrous material can be created as described in U.S. patent application Ser. No. 13/029154, entitled “Computer Based Modeling of Fibrous Materials,” which is hereby incorporated by reference. Similarly, program instructions can also execute to represent other fibrous materials with computer based models of those fibrous materials.

In various embodiments of the computer based methods of the present disclosure, the layer of fibrous material 213-a-1 can be replaced with any fibrous material, configured in any way described herein or known in the art. The fibrous material can be of any size and shape. The fibrous material can be of any length, any width, and any thickness, any of which can be uniform or variable in any direction over part, parts, or all of the fibrous material. The fibrous material can be made of any material. For example, the fibrous material can be made of paper, textile, nonwoven, plastic, etc. The fibrous material can have any number of fibers, including a monofilament (single fiber). Part, parts, or all of the fibrous material can have one or more additional layers and can also be made of multiple materials, joined together in any way. The surface of the fibrous material can be continuous or discontinuous, over part, parts, or all of the fibrous material. Any of the variations described above and any other variations known in the art can be combined in any way, in any of the embodiments of fibrous material described herein. In various embodiments, a fibrous material can also be considered a textured material and/or porous material.

FIG. 2D is a front view of an exemplary layer of textured material 213-a-2, within a reference area 203. The layer of textured material 213-a-2 includes raised areas 222-a and recessed areas 227-a, which form the texture. The layer of textured material 213-a-2 also includes a solid, continuous base 268.

The raised areas 222-a are fully opaque. However, in alternate embodiments, the raised areas can have an opacity from 0-99% (including any integer percent value in this range, and any range formed by any of these integer values), can be substantially opaque, can be substantially transparent, or can be fully transparent. Also, in various alternate embodiments, the raised areas can have varying degrees of opacity, and each of the raised areas can have any degree of opacity described herein.

The recessed areas 227-a are fully opaque. However, in alternate embodiments, the recessed areas can have an opacity from 0-99% (including any integer percent value in this range, and any range formed by any of these integer values), can be substantially opaque, can be substantially transparent, or can be fully transparent. Also, in various alternate embodiments, the recessed areas can have varying degrees of opacity, and each of the recessed areas can have any degree of opacity described herein.

FIG. 2E is a side view of the layer of textured material 213-a-2 of FIG. 2D. The textured material 213-a-2 includes a front surface 220-a and a back surface 260-a. The front surface 220-a includes the raised areas 222-a and the recessed areas 227-a disposed between the raised areas 222-a. The back surface 260-a is on the back of the base 268.

FIG. 2F is a bottom view of the layer of textured material 213-a-2 of FIG. 2D.

Program instructions can execute to represent the layer of textured material 213-a-2 with a computer based model of the layer of textured material. The model can be configured to represent the geometries of raised areas and recessed areas in the layer of textured material. The model can also be configured to represent the physical properties of the textured material, including the opacities of the raised areas and the recessed areas. In various embodiments, the layer of textured material 213-a-2 can be created as a computer based model by drawing the material, scanning the material, or generating a model of the material image with other program instructions. Similarly, program instructions can also execute to represent other textured materials with computer based models of those textured materials.

In various embodiments, program instructions can execute to separately represent the raised areas 222-a, apart from other elements, with a computer based model, which can be used with a masking function and/or an opacity function, as discussed herein. Also, in various embodiments, program instructions can execute to separately represent the recessed areas 227-a, apart from other elements, with a computer based model, which can be used with a masking function and/or an opacity function, as discussed herein. Further, in various embodiments, program instructions can execute to separately represent the base 268, apart from other elements, with a computer based model, which can be used with a masking function and/or an opacity function, as discussed herein.

In various embodiments of the computer based methods of the present disclosure, the layer of textured material 213-a-2 can be replaced with any textured material, configured in any way described herein or known in the art. The textured material can be of any size and shape. The textured material can be of any length, any width, and any thickness, any of which can be uniform or variable in any direction over part, parts, or all of the textured material. The textured material can be made of any material. For example, the textured material can be made of paper, textile, nonwoven, plastic, etc. Part, parts, or all of the textured material can have one or more additional layers and can also be made of multiple materials, joined together in any way. The surface of the textured material can be continuous or discontinuous, over part, parts, or all of the textured material. Part, parts, or all of either of the surfaces of the textured material can have recesses, or can have raised areas, or any combination of these. The textured material can have any number of any kind of raised areas, of any size and shape, configured in any way, in any combination. Any of the variations described above and any other variations known in the art can be combined in any way, in any of the embodiments of textured material described herein.

FIG. 2G is a front view of an exemplary layer of porous material 213-a-3, within a reference area 203. The layer of porous material 213-a-3 includes pores, which are open areas 225 that extend through the material. The layer of porous material 213-a-3 also includes a material area, which is the portion of the layer formed by the substance of the layer, that is, the portion of the layer that is outside of the open areas 225.

The material area is fully opaque. However, in alternate embodiments, the material area can have an opacity from 0-99% (including any integer percent value in this range, and any range formed by any of these integer values), can be substantially opaque, can be substantially transparent, or can be fully transparent. Also, in various alternate embodiments, the material area can have varying degrees of opacity, and any portion of the material area can have any degree of opacity described herein.

FIG. 2H is a sectional view of the layer of porous material 213-a-3 of FIG. 2G. The layer of porous material 213-a-3 includes a front surface 220-a and a back surface 260-a. The front surface 220-a includes the surface of the material area and the open areas 225 disposed within and separated by the material. The back surface 260-a includes the surface of the material area and the open areas 225 disposed within and separated by the material.

FIG. 2I is a bottom view of the layer of porous material 213-a-3 of FIG. 2G. Program instructions can execute to represent the layer of porous material 213-a-3 with a computer based model of the layer of porous material. The model can be configured to represent the geometries of the material area and the open areas in the layer of porous material. The model can also be configured to represent the physical properties of the material area, including the opacity of the material area. In various embodiments, the layer of porous material 213-a-3 can be created as a computer based model by drawing the material, scanning the material, or generating a model of the material image with other program instructions. Similarly, program instructions can also execute to represent other porous materials with computer based models of those porous materials.

In various embodiments, program instructions can execute to separately represent the material area, apart from other elements, with a computer based model, which can be used with a masking function and/or an opacity function, as discussed herein. Also, in various embodiments, program instructions can execute to separately represent the open areas 225, apart from other elements, with a computer based model, which can be used with a masking function and/or an opacity function, as discussed herein.

In various embodiments of the computer based methods of the present disclosure, the layer of porous material 213-a-3 can be replaced with any porous material, configured in any way described herein or known in the art. The porous material can be of any size and shape. The porous material can be of any length, any width, and any thickness, any of which can be uniform or variable in any direction over part, parts, or all of the porous material. The porous material can be made of any material. For example, the porous material can be made of paper, textile, nonwoven, plastic, etc. Part, parts, or all of the porous material can have one or more additional layers and can also be made of multiple materials, joined together in any way. The surface of the porous material can be continuous or discontinuous, over part, parts, or all of the porous material. Some or all of the pores can extend all the way through the porous material or can extend only partway through the porous material. Any of the variations described above and any other variations known in the art can be combined in any way, in any of the embodiments of porous material described herein.

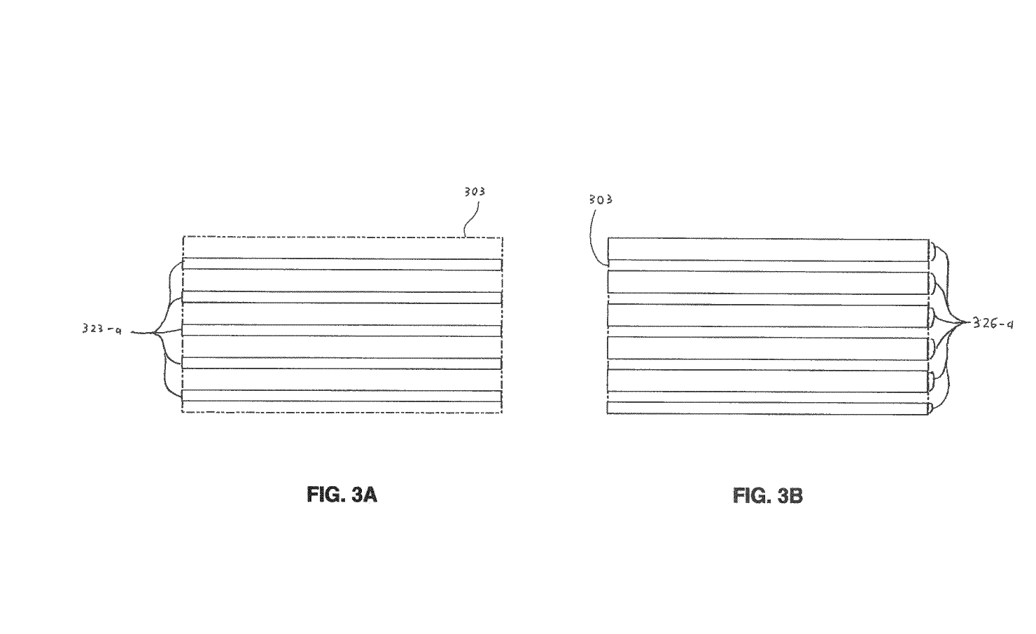

FIG. 3A is a front view of front fibers 323-a, within a reference area 303. The front fibers 323-a are the same as the front fibers 223-a of FIG. 2A. However, in FIG. 3A, the front fibers 323-a are shown separate from other elements. The reference area 303 is the same size and shape as the reference area 103. Program instructions can execute to represent the front fibers 323-a with a computer based model of the front fibers. In various embodiments, program instructions can execute to separately represent the front fibers 323-a, apart from other elements. In various embodiments, a model of front fibers can be used with a masking function and/or an opacity function, as discussed herein.

FIG. 3B is a front view of front open areas 326-a, within the reference area 303. The front open areas 326-a are the same as the front open areas 226-a of FIG. 2A. However, in FIG. 3B, the front open areas 326-a are shown separate from other elements. Program instructions can execute to represent the front open areas 326-a with a computer based model of the front open areas. In various embodiments, program instructions can execute to separately represent the front open areas 326-a, apart from other elements. In various embodiments, a model of front open can be used with a masking function, as discussed herein.

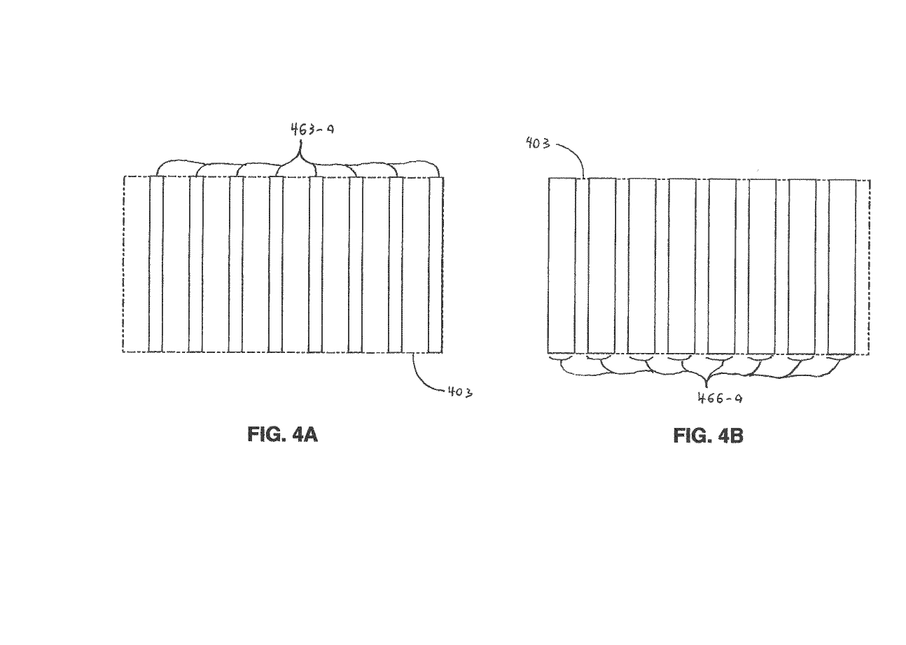

FIG. 4A is a front view of back fibers 463-a, within a reference area 403. The back fibers 463-a are the same as the back fibers 263-a of FIG. 2A. However, in FIG. 4A, the back fibers 463-a are shown separate from other elements. The reference area 403 is the same size and shape as the reference area 103. Program instructions can execute to represent the back fibers 463-a with a computer based model of the back fibers. In various embodiments, program instructions can execute to separately represent the back fibers 463-a, apart from other elements. In various embodiments, a model of back fibers can be used with a masking function and/or an opacity function, as discussed herein.

FIG. 4B is a front view of back open areas 466-a, within the reference area 403. The back open areas 466-a are the same as the back open areas 266-a of FIG. 2A. However, in FIG. 4A, the back open areas 466-a are shown separate from other elements. Program instructions can execute to represent the back open areas 466-a with a computer based model of the back open areas. In various embodiments, program instructions can execute to separately represent the back open areas 466-a, apart from other elements. In various embodiments, a model of back open can be used with a masking function, as discussed herein.

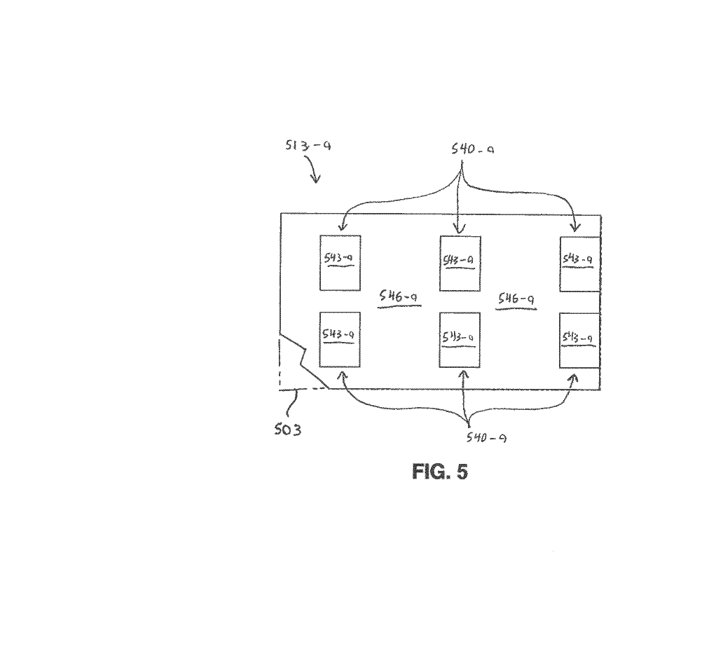

FIG. 5 is a front view of an exemplary layer of a bonded material 513-a, within a reference area 503. The lower left corner of the bonded material 513-a is shown as broken away, in order to show the reference area 503. The reference area 503 is the same size and shape as the reference area 103. The bonded material 513-a includes a front surface and a back surface. The bonded material 513-a includes a bond pattern 540-a with bond areas 543-a. The bonded material 513-a also includes an unbonded area 546-a outside of the bond areas 543-a.

The unbonded area 546-a is fully opaque. However, in alternate embodiments, the unbonded area can have an opacity from 0-99% (including any integer percent value in this range, and any range formed by any of these integer values), can be substantially opaque, can be substantially transparent, or can be fully transparent. Also, in various alternate embodiments, the unbonded area can have varying degrees of opacity, and any portion of the unbonded area can have any degree of opacity described herein.

The bond areas 543-a are fully transparent. However, in alternate embodiments, the bond areas can have an opacity from 1-100% (including any integer percent value in this range, and any range formed by any of these integer values), can be substantially transparent, can be substantially opaque, or can be fully opaque. Also, in various alternate embodiments, the bond areas can have varying degrees of opacity, and each of the bond areas can have any degree of opacity described herein.

Program instructions can execute to represent the layer of bonded material 513-a with a computer based model of the layer of bonded material. The model can be configured to represent the geometries of the bond areas and the unbonded area in the layer of bonded material. The model can also be configured to represent the physical properties of the bond areas and the unbonded area, including their opacities. Similarly, program instructions can also execute to represent other bonded materials with computer based models of those bonded materials.

In various embodiments of the computer based methods of the present disclosure, the layer of bonded material 513-a can be replaced with any bonded material, configured in any way described herein or known in the art. The bonded material can be of any size and shape. The bonded material can be of any length, any width, and any thickness, any of which can be uniform or variable in any direction over part, parts, or all of the bonded material. The bonded material can be made of any material and the bond pattern can be applied to any material. For example, the bonded material can be made of paper, textile, nonwoven, plastic, etc. Part, parts, or all of the bonded material can have one or more additional layers and can also be made of multiple materials, joined together in any way. The surface of the bonded material can be continuous or discontinuous, over part, parts, or all of the bonded material. The bonded material can have any number of any kind of bond, of any size, shape, pattern, and distribution, configured in any way, in any combination. Any of the variations described above and any other variations known in the art can be combined in any way, in any of the embodiments of bonded material described herein.

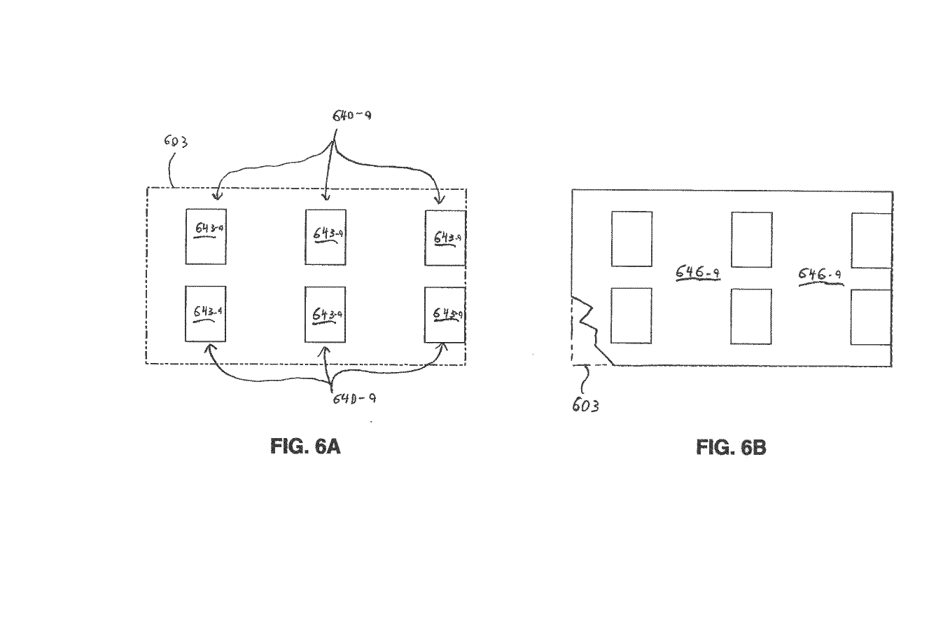

FIG. 6A is a front view of bond pattern 640-a with bond areas 643-a within a reference area 603. The bond pattern 640-a is the same as the bond pattern 540-a of FIG. 5. The bond areas 643-a are the same as the bond areas 543-a of FIG. 5. However, in FIG. 6A, the bond areas 643-a are shown separate from other elements. The reference area 603 is the same size and shape as the reference area 103. Program instructions can execute to represent the bond pattern 640-a with a computer based model of the bond pattern. Program instructions can also execute to represent the bond areas 643-a with a computer based model of the bond areas. In various embodiments, program instructions can execute to separately represent the bond pattern 640-a and/or the bond areas 643-a, apart from other elements. In various embodiments, a model of bond areas can be used with a masking function and/or an opacity function, as discussed herein.

FIG. 6B is a front view of unbonded area 646-a, within a reference area 603. The lower left corner of the unbonded area 646-a is shown as broken away, in order to show the reference area 603. The reference area 603 is the same size and shape as the reference area 103. The unbonded area 646-a is the same as the unbonded area 546-a of FIG. 5. However, in FIG. 6A, the unbonded area 646-a is shown separate from other elements. The outer edge of the unbonded area 646-a coincides with the reference area 603. Program instructions can execute to represent the unbonded area 646-a with a computer based model of the unbonded area. In various embodiments, program instructions can execute to separately represent the unbonded area 646-a, apart from other elements. In various embodiments, a model of an unbonded area can be used with a masking function and/or an opacity function, as discussed herein.

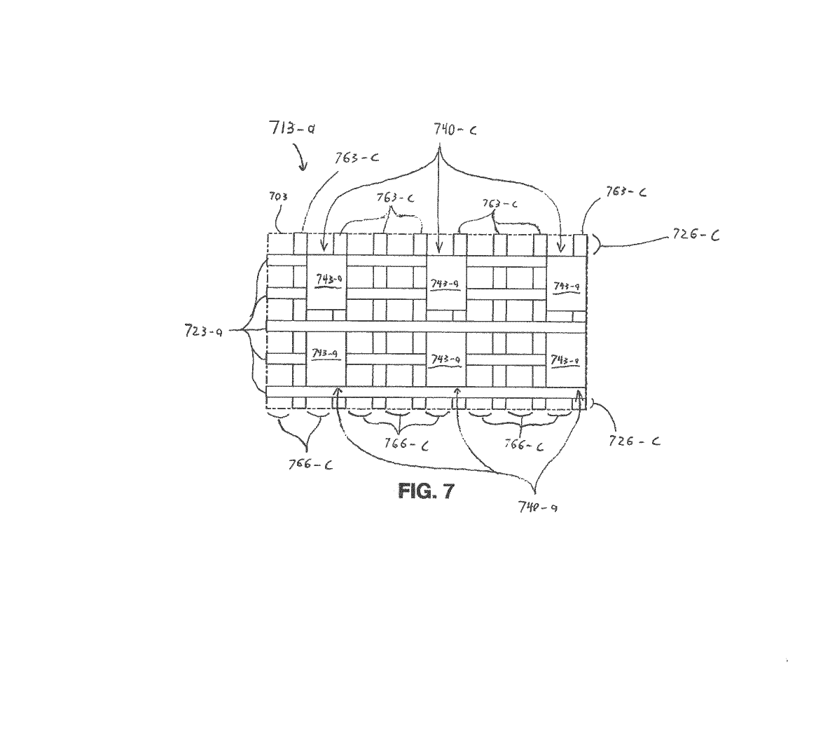

FIG. 7 is a front view of an exemplary layer of bonded fibrous material 713-a, within a reference area 703. The bonded fibrous material 713-a includes a front surface and a back surface. The bonded fibrous material 713-a includes a fibrous material configured in the same way as in the fibrous material 213-a-1 of FIGS. 2A-2C, with like-numbered elements configured in the same way. The bonded fibrous material 713-a includes front fibers 723-a and back fibers 763-a. The bonded fibrous material 713-a also includes a bond pattern 740-a configured in the same way as the bond pattern 540-a of FIG. 5A. The bonded fibrous material 713-a includes bond areas 743-a configured in the same way as the bond areas 543-a of FIG. 5A and an unbonded area that is the same size and shape as the unbonded area 546-a of FIG. 5A. The reference area 703 is the same size and shape as the reference area 103. Program instructions can execute to represent the bonded fibrous material 713-a with a computer based model of the bonded fibrous material. The model can be configured to represent the geometries of the fibers, the bond areas, and the unbonded area in the layer of fibrous bonded material. The model can also be configured to represent the physical properties of the fibers and the bond areas, including their opacities. In various embodiments, the bonded fibrous material 713-a can be created as a computer based model by drawing the material, scanning the material, or generating a model of the material with other program instructions. Similarly, program instructions can also execute to represent other bonded fibrous materials with computer based models of those bonded fibrous materials, including any aspects of any fibrous material and/or any aspects of any bonded material, as disclosed herein and/or known in the art, in any combination.

The bond areas 743-a are fully transparent. However, in alternate embodiments, the bond areas can have an opacity from 1-100% (including any integer percent value in this range, and any range formed by any of these integer values), can be substantially transparent, can be substantially opaque, or can be fully opaque. Also, in various alternate embodiments, the bond areas can have varying degrees of opacity, and each of the bond areas can have any degree of opacity described herein.

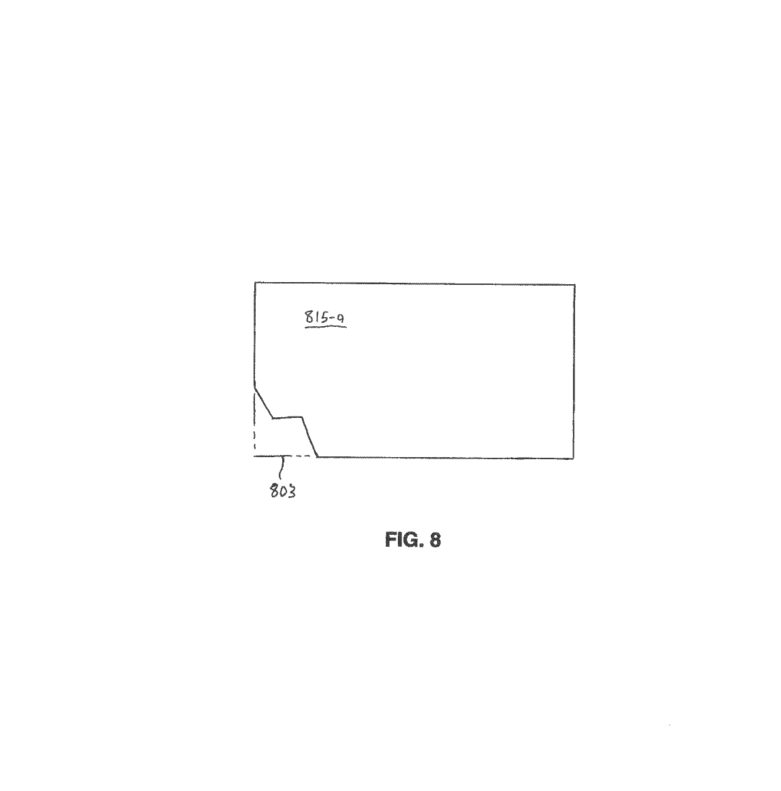

FIG. 8 is a front view of a background material 815-a, within a reference area 803. The lower left corner of the background material 815-a is shown as broken away, in order to show the reference area 803. The reference area 803 is the same size and shape as the reference area 103. The background material 815-a includes a front surface and a back surface. The reference area 803 is the same size and shape as the reference area 103. The outer edge of the background material 815-a coincides with the reference area 803.

The background material 815-a is fully opaque. However, in alternate embodiments, the background material can have an opacity from 0-99% (including any integer percent value in this range, and any range formed by any of these integer values), can be substantially opaque, can be substantially transparent, or can be fully transparent. Also, in various alternate embodiments, the background material can have varying degrees of opacity, and any portion of the background material can have any degree of opacity described herein.

Program instructions can execute to represent the background material 815-a with a computer based model of the background material. Similarly, program instructions can also execute to represent other background materials with computer based models of those background materials. In various embodiments of the computer based methods of the present disclosure, the background material 815-a can be replaced with any material, configured in any way described herein or known in the art.

As used herein, the following meanings apply, the term “masking function” refers to program instructions that can execute such that, in a printed material, portions of an artwork image that correspond with one or more defined locations are not displayed when a computer based model represents the appearance of the printed material. Similarly, a “masking function” can also refer to program instructions that can execute such that, in a printed material, only portions of an artwork image that correspond with an inverse of one or more defined locations are displayed when a computer based model represents the appearance of the printed material.

The term “opacity function” refers to program instructions that can execute such that, in a printed material, portions of an artwork image that correspond with one or more defined locations are displayed with reduced intensity when a computer based model represents the appearance of the printed material. Similarly, an “opacity function” can also refer to program instructions that can execute such that, in a printed material, only portions of an artwork image that correspond with an inverse of one or more defined locations are not displayed with reduced intensity when a computer based model represents the appearance of the printed material.

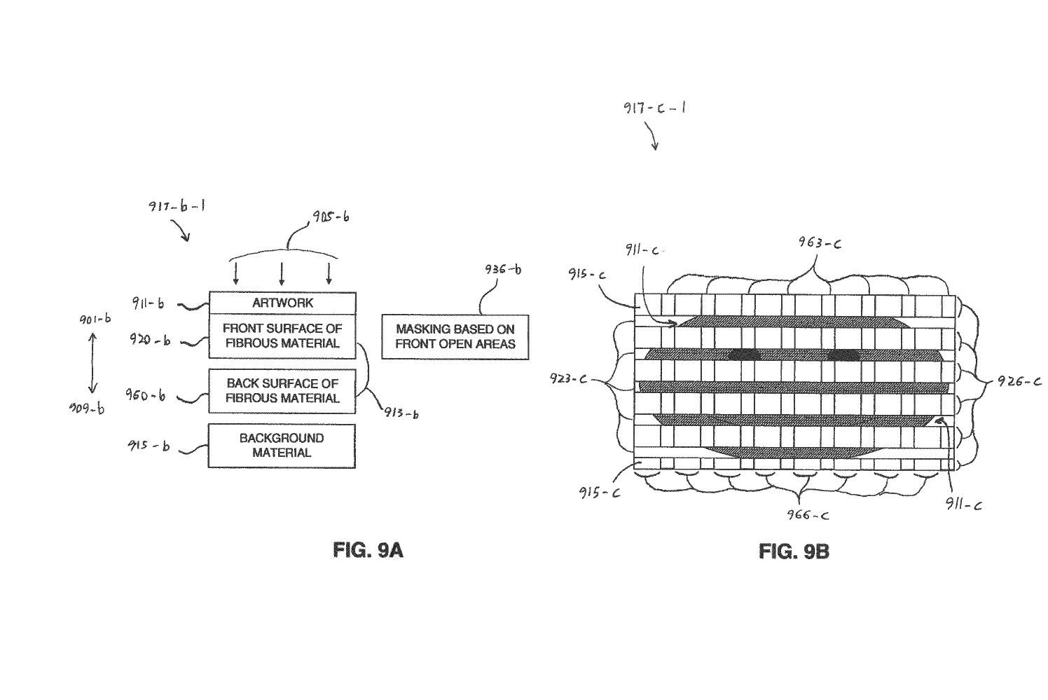

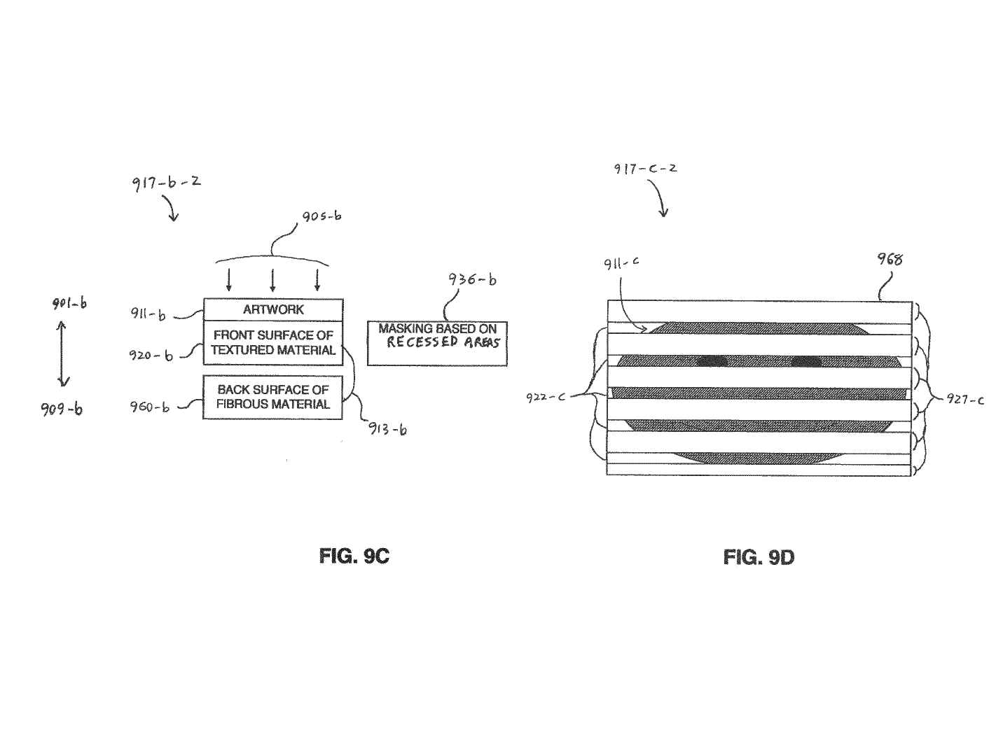

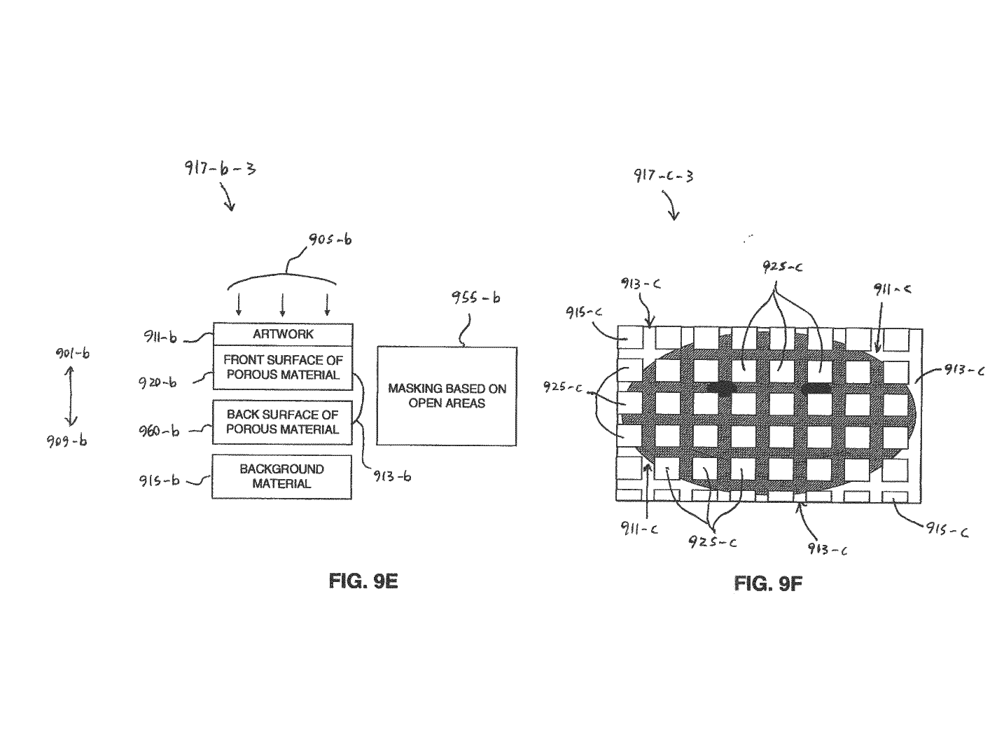

FIG. 9A is a block diagram of a computer based model 917-b-1 of a printed material having an artwork image printed on a front surface of a layer of fibrous material and an unprinted background material that is disposed in back of the fibrous material. In the model 917-b-1, and in each of the models described and illustrated herein, the printing can be accomplished by any means known in the art. For example, the printing can be flexographic printing, gravure printing, inkjet printing, offset printing, lithographic printing, or any other kind of printing known to one of skill in the art, etc.

The model 917-b-1 includes a front direction 901-b and a back direction 909-b. In the model 917-b-1, a representation of a front appearance of the printed material is created from viewing direction 905-b, which is located in front 901-b of the printed material and directed toward the back 909-b.

The model 917-b-1 includes a computer based model 911-b representing the artwork image 111-a of FIG. 1 and configured in the same way. The model 917-b-1 also includes a computer based model 913-b representing the layer of fibrous material 213-a-1 of FIGS. 2A-2C, with elements of the model configured in the same way as like-numbered elements of the modeled material. The model 917-b-1 further includes a computer based model 915-b representing the background material 815-a of FIG. 8 and configured in the same way. In the model 917-b-1, and in each of the models described and illustrated herein, each of the reference areas are aligned to coincide with each other.

In the model 913-b of the fibrous material, the fibrous material is a material that includes a front surface 920-b and a back surface 960-b. The front surface 920-b includes front fibers 923-b and front open areas 926-b. The back surface 960-b includes back fibers 963-b and back open areas 966-b.

In the model 917-b-1, the model 911-b of the artwork is represented as printed on the front surface 920-b of the model 913-b of the fibrous material and the model 915-b of the background material is represented as disposed in back 909-b of the model 913-b of the fibrous material. In the model 915-b of the background material, the background material is represented as unprinted.

In the embodiment of FIG. 9A, program instructions can execute to transform the computer based model 917-b-1. This transforming includes compositing at least a portion of the model 911-b of the artwork image with at least a portion of the model 913-b of the fibrous material.

In FIG. 9A, this compositing includes modulating the model 911-b of the artwork image with a masking function 935-b. The masking function 935-b applies to the model 911-b at locations that are based on the front open areas 926-b, because the front open areas 926-b cannot be printed with the artwork image. When the masking function 935-b is applied, program instructions can execute such that the portions of the artwork image that correspond with the locations of the front open areas 926-b are not displayed when the model 917-b-1 represents the front appearance of the composited printed material.

In various embodiments, the model 917-b-1 can be alternatively configured with any alternate embodiment of artwork, and/or any alternate embodiment of fibrous material, and/or any alternate embodiment of background material, as described herein or as known in the art, in any combination, and program instructions can execute to transform such alternate embodiments, to represent the appearance of a printed material, as described herein.

FIG. 9B is an illustration 917-c-1 of a front appearance of the composited printed material of FIG. 9A, as displayed by the computer based model 917-b-1. The illustration 917-c-1 displays the front fibers 923-c, portions of the back fibers 926-c that are not obstructed by the front fibers 923-c, and portions of the background material 915-c that are not obstructed by the front fibers 923-c and/or the back fibers 926-c.

In FIG. 9B, portions of the artwork image are displayed. This represents the printing of the artwork image on the front of the fibrous material 913-c. The portions of the artwork image that correspond with the locations of the front fibers 923-c are displayed. This represents the printing of the artwork image on the front fibers 923-c. The portions of the artwork image that do not correspond with the locations of the front fibers 923-c are not displayed. This represents the absence of printing outside of the front fibers 923-c.

FIG. 9C is a block diagram of a computer based model 917-b-2 of a printed material having an artwork image printed on a front surface of a layer of textured material. The model 917-b-2 includes a front direction 901-b and a back direction 909-b. In the model 917-b-2, a representation of a front appearance of the printed material is created from viewing direction 905-b, which is located in front 901-b of the printed material and directed toward the back 909-b.

The model 917-b-2 includes a computer based model 911-b representing the artwork image 111-a of FIG. 1 and configured in the same way. The model 917-b-2 also includes a computer based model 913-b representing the layer of textured material 213-a-2 of FIGS. 2D-2F, with elements of the model configured in the same way as like-numbered elements of the modeled material.

In the model 913-b of the textured material, the textured material is a material that includes a front surface 920-b and a back surface 960-b. The front surface 920-b includes raised areas 922-b and recessed areas 927-b. The back surface 960-b is on the back of a base 968.

In the model 917-b-2, the model 911-b of the artwork is represented as printed on the front surface 920-b of the model 913-b of the textured material. In the embodiment of FIG. 9C, program instructions can execute to transform the computer based model 917-b-2. This transforming includes compositing at least a portion of the model 911-b of the artwork image with at least a portion of the model 913-b of the textured material.

In FIG. 9C, this compositing includes modulating the model 911-b of the artwork image with a masking function 936-b. The masking function 936-b applies to the model 911-b at locations that are based on the recessed areas 927-b, because the recessed areas 927-b are not printed with the artwork image. When the masking function 936-b is applied, program instructions can execute such that the portions of the artwork image that correspond with the locations of the recessed areas 927-b are not displayed when the model 917-b-2 represents the front appearance of the composited printed material. In alternate embodiments, where the textured material is not fully opaque an opacity function can also be applied to the model 911-b, at locations that are based on the recessed areas.

In various embodiments, the model 917-b-2 can be alternatively configured with any alternate embodiment of artwork, and/or any alternate embodiment of textured material, as described herein or as known in the art, in any combination, and program instructions can execute to transform such alternate embodiments, to represent the appearance of a printed material, as described herein.

FIG. 9D is an illustration 917-c-2 of a front appearance of the composited printed material of FIG. 9C, as displayed by the computer based model 917-b-2. The illustration 917-c-2 displays the raised areas 922-c and the recessed areas 927-b.

In FIG. 9D, portions of the artwork image are displayed. This represents the printing of the artwork image on the front of the textured material 913-c. The portions of the artwork image that correspond with the locations of the raised areas 922-c are displayed. This represents the printing of the artwork image on the raised areas 922-c. The portions of the artwork image that do not correspond with the locations of the raised areas 922-c are not displayed. This represents the absence of printing outside of the raised areas 922-c.

FIG. 9E is a block diagram of a computer based model 917-b-3 of a printed material having an artwork image printed on a front surface of a layer of porous material. The model 917-b-3 includes a front direction 901-b and a back direction 909-b. In the model 917-b-3, a representation of a front appearance of the printed material is created from viewing direction 905-b, which is located in front 901-b of the printed material and directed toward the back 909-b.

The model 917-b-3 includes a computer based model 911-b representing the artwork image 111-a of FIG. 1 and configured in the same way. The model 917-b-3 also includes a computer based model 913-b representing the layer of porous material 213-a-3 of FIGS. 2G-2I, with elements of the model configured in the same way as like-numbered elements of the modeled material.

In the model 913-b of the porous material, the porous material includes a front surface 920-b and a back surface 960-b. The layer of porous material includes pores, which are open areas 925 that extend through the layer, from the front surface 920-b to the back surface 960-b.

In the model 917-b-3, the model 911-b of the artwork is represented as printed on the front surface 920-b of the model 913-b of the porous material. In the embodiment of FIG. 9E, program instructions can execute to transform the computer based model 917-b-3. This transforming includes compositing at least a portion of the model 911-b of the artwork image with at least a portion of the model 913-b of the porous material.

In FIG. 9E, this compositing includes modulating the model 911-b of the artwork image with a masking function 955-b. The masking function 955-b applies to the model 911-b at locations that are based on the open areas 925-b, because the open areas 925-b cannot be printed with the artwork image. When the masking function 955-b is applied, program instructions can execute such that the portions of the artwork image that correspond with the locations of the open areas 925-b are not displayed when the model 917-b-3 represents the front appearance of the composited printed material. In alternate embodiments, where the porous material is not fully opaque an opacity function can also be applied to the model 911-b, at locations that are based on the material area.

In various embodiments, the model 917-b-3 can be alternatively configured with any alternate embodiment of artwork, and/or any alternate embodiment of porous material, and/or any alternate embodiment of background material, as described herein or as known in the art, in any combination, and program instructions can execute to transform such alternate embodiments, to represent the appearance of a printed material, as described herein.

FIG. 9F is an illustration 917-c-3 of a front appearance of the composited printed material of FIG. 9E, as displayed by the computer based model 917-b-3. The illustration 917-c-3 displays the material area of the layer of material 913-c and portions of the background material 915-c that are not obstructed by the material area of the layer of material 913-c.

In FIG. 9F, portions of the artwork image are displayed. This represents the printing of the artwork image on the front of the porous material 913-c. The portions of the artwork image that correspond with the locations of the material area of the layer of material 913-c are displayed. This represents the printing of the artwork image on the layer of material 913-c. The portions of the artwork image that do not correspond with the locations of the material area are not displayed. This represents the absence of printing outside of the material area.

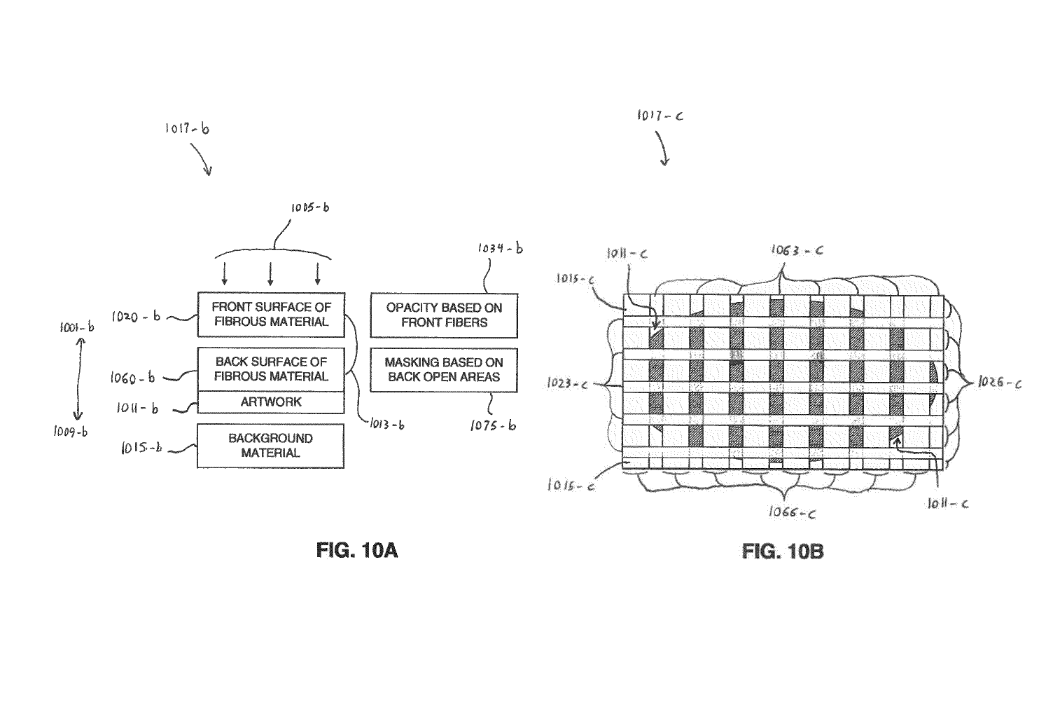

FIG. 10A is a block diagram of a computer based model 1017-b of a printed material having an artwork image printed on a back surface of a layer of fibrous material and an unprinted background material that is disposed in back of the fibrous material.

The model 1017-b includes a front direction 1001-b and a back direction 1009-b. In the model 1017-b, a representation of a front appearance of the printed material is created from viewing direction 1005-b, which is located in front 1001-b of the printed material and directed toward the back 1009-b.

The model 1017-b includes a computer based model 1011-b representing the artwork image 111-a of FIG. 1 and configured in the same way. The model 1017-b also includes a computer based model 1013-b representing the layer of fibrous material 213-a-1 of FIGS. 2A-2C, with elements of the model configured in the same way as like-numbered elements of the modeled material. The model 1017-b further includes a computer based model 1015-b representing the background material 815-a of FIG. 8 and configured in the same way.

In the model 1013-b of the fibrous material, the fibrous material is a material that includes a front surface 1020-b and a back surface 1060-b. The front surface 1020-b includes front fibers 1023-b and front open areas 1026-b. The back surface 1060-b includes back fibers 1063-b and back open areas 1066-b.

In the model 1017-b, the model 1011-b of the artwork is represented as printed on the back surface 1060-b of the model 1013-b of the fibrous material and the model 1015-b of the background material is represented as disposed in back 1009-b of the model 1013-b of the fibrous material. In the model 1015-b of the background material, the background material is represented as unprinted.

In the embodiment of FIG. 10A, program instructions can execute to transform the computer based model 1017-b. This transforming includes compositing at least a portion of the model 1011-b of the artwork image with at least a portion of the model 1013-b of the fibrous material.

In FIG. 10A, this compositing includes modulating the model 1011-b of the artwork image with a masking function 1075-b. The masking function 1075-b applies to the model 1011-b at locations that are based on the back open areas 1066-b, because the back open areas 1066-b cannot be printed with the artwork image. When the masking function 1075-b is applied, program instructions can execute such that the portions of the artwork image that correspond with the locations of the back open areas 1066-b are not displayed when the model 1017-b represents the front appearance of the composited printed material.

In FIG. 10A, the compositing also includes modulating the model 1011-b of the artwork image with an opacity function 1034-b. The opacity function 1034-b applies to the model 1011-b at locations that are based on the front fibers 1023-b, because the front fibers 1023-b have a limited ability to transmit the light from the artwork image. When the opacity function 1034-b is applied, program instructions can execute such that the portions of the artwork image that correspond with the locations of the front fibers 1023-b are displayed with reduced intensity when the model 1017-b represents the front appearance of the composited printed material.

In various embodiments, the model 1017-b can be alternatively configured with any alternate embodiment of artwork, and/or any alternate embodiment of fibrous material, and/or any alternate embodiment of background material, as described herein or as known in the art, in any combination, and program instructions can execute to transform such alternate embodiments, to represent the appearance of a printed material, as described herein.

FIG. 10B is an illustration 1017-c of a front appearance of the composited printed material of FIG. 10A, as displayed by the computer based model 1017-b. The illustration 1017-c displays the front fibers 1023-c, portions of the back fibers 1026-c that are not obstructed by the front fibers 1023-c, and portions of the background material 1015-c that are not obstructed by the front fibers 1023-c and/or the back fibers 1026-c.

In FIG. 10B, portions of the artwork image are displayed. This represents the printing of the artwork image on the back of the fibrous material 1013-c. The portions of the artwork image that correspond with the locations of the back fibers 1063-c are displayed. This represents the printing of the artwork image on the back fibers 1063-c. The portions of the artwork image that correspond with both the locations of the back fibers 1063-c and the locations of the front fibers 1023-c are displayed with reduced intensity. This represents the opacity of the front fibers 1023-c. The portions of the artwork image that correspond with the locations of the back fibers 1063-c but do not correspond with the locations of the front fibers 1023-c are displayed without reduced intensity. This represents the absence of the opacity of the front fibers 1023-c.

The portions of the artwork image that do not correspond with the locations of the back fibers 1063-c are not displayed. This represents the absence of printing outside of the back fibers 1063-c.

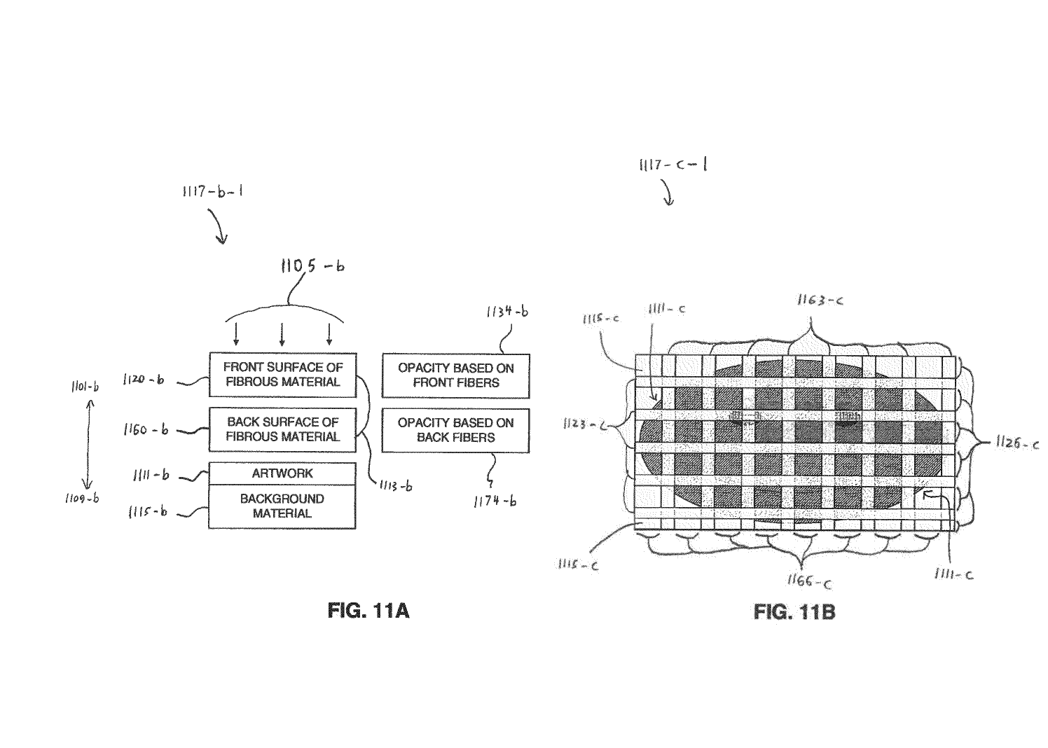

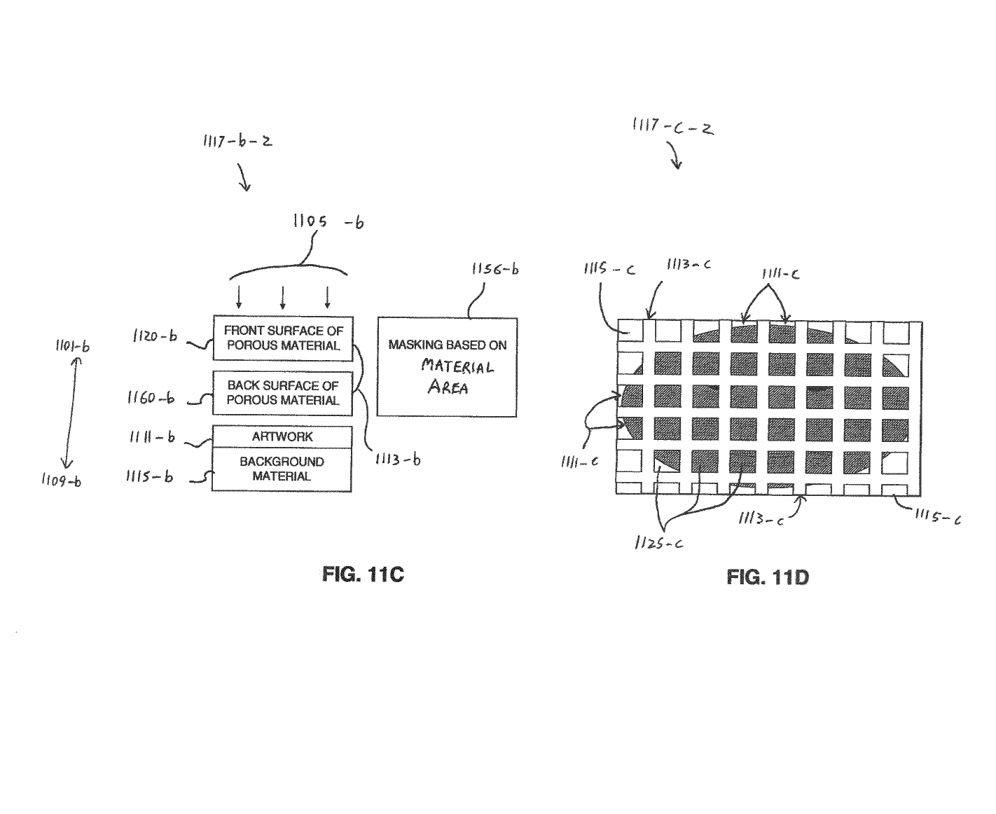

FIG. 11A is a block diagram of a computer based model 1117-b-1 of a printed material having an artwork image printed on a front surface of a background material that is disposed in back of a fibrous material.

The model 1117-b-1 includes a front direction 1101-b and a back direction 1109-b. In the model 1117-b-1, a representation of a front appearance of the printed material is created from viewing direction 1105-b, which is located in front 1101-b of the printed material and directed toward the back 1109-b.

The model 1117-b-1 includes a computer based model 1111-b representing the artwork image 111-a of FIG. 1 and configured in the same way. The model 1117-b-1 also includes a computer based model 1113-b representing the layer of fibrous material 213-a-1 of FIGS. 2A-2C, with elements of the model configured in the same way as like-numbered elements of the modeled material. The model 1117-b-1 further includes a computer based model 1115-b representing the background material 815-a of FIG. 8 and configured in the same way.

In the model 1113-b of the fibrous material, the fibrous material is a material that includes a front surface 1120-b and a back surface 1160-b. The front surface 1120-b includes front fibers 1123-b and front open areas 1126-b. The back surface 1160-b includes back fibers 1163-b and back open areas 1166-b.

In the model 1117-b-1, the model 1111-b of the artwork is represented as printed on the front surface of the model 1115-b of the background material and the model 1115-b of the background material is represented as disposed in back 1109-b of the model 1113-b of the fibrous material. In the model 1113-b of the fibrous material, the fibrous material is represented as unprinted.

In the embodiment of FIG. 11A, program instructions can execute to transform the computer based model 1117-b-1. This transforming includes compositing at least a portion of the model 1111-b of the artwork image with at least a portion of the model 1113-b of the fibrous material.

In FIG. 11A, this compositing includes modulating the model 1111-b of the artwork image with an opacity function 1134-b, because the front fibers 1123-b have a limited ability to transmit the light from the artwork image. The opacity function 1134-b applies to the model 1111-b at locations that are based on the front fibers 1123-b. When the opacity function 1134-b is applied, program instructions can execute such that the portions of the artwork image that correspond with the locations of the front fibers 1123-b are displayed with reduced intensity when the model 1117-b-1 represents the front appearance of the composited printed material.

In FIG. 11A, the compositing also includes modulating the model 1111-b of the artwork image with an opacity function 1174-b, because the back fibers 1163-b have a limited ability to transmit the light from the artwork image. The opacity function 1174-b applies to the model 1111-b at locations that are based on the back fibers 1163-b. When the opacity function 1174-b is applied, program instructions can execute such that the portions of the artwork image that correspond with the locations of the back fibers 1163-b are displayed with reduced intensity when the model 1117-b-1 represents the front appearance of the composited printed material.

In various embodiments, the model 1117-b-1 can be alternatively configured with any alternate embodiment of artwork, and/or any alternate embodiment of fibrous material, and/or any alternate embodiment of background material, as described herein or as known in the art, in any combination, and program instructions can execute to transform such alternate embodiments, to represent the appearance of a printed material, as described herein.

FIG. 11B is an illustration 1117-c-1 of a front appearance of the composited printed material of FIG. 11A, as displayed by the computer based model 1117-b-1. The illustration 1117-c-1 displays the front fibers 1123-c, portions of the back fibers 1126-c that are not obstructed by the front fibers 1123-c, and portions of the background material 1115-c that are not obstructed by the front fibers 1123-c and/or the back fibers 1126-c.

In FIG. 11B, portions of the artwork image are displayed. This represents the printing of the artwork image on the front of the background material 1115-c. The portions of the artwork image that correspond with the locations of the front fibers 1123-c are displayed with reduced intensity. This represents the opacity of the front fibers 1123-c. The portions of the artwork image that correspond with the locations of the back fibers 1163-c are also displayed with reduced intensity. This represents the opacity of the back fibers 1163-c. The portions of the artwork image that correspond with both the locations of the front fibers 1013-c and the locations of the back fibers 1163-c are displayed with greatly reduced intensity. This represents the combined opacity of the front fibers 1123-c and the back fibers 1163-c.

The portions of the artwork image that do not correspond with the locations of the front fibers 1123-c and that do not correspond with the locations of the back fibers 1163-c are displayed without reduced intensity. This represents the absence of the opacity of the front fibers 1123-c and the absence of the opacity of the back fibers 1163-c.

FIG. 11C is a block diagram of a computer based model 1117-b-2 of a printed material having an artwork image printed on a front surface of a background material that is disposed in back of a porous material.

The model 1117-b-2 includes a front direction 1101-b and a back direction 1109-b. In the model 1117-b-2, a representation of a front appearance of the printed material is created from viewing direction 1105-b, which is located in front 1101-b of the printed material and directed toward the back 1109-b.

The model 1117-b-2 includes a computer based model 1111-b representing the artwork image 111-a of FIG. 1 and configured in the same way. The model 1117-b-2 also includes a computer based model 1113-b representing the layer of porous material 213-a-3 of FIGS. 2G-2I, with elements of the model configured in the same way as like-numbered elements of the modeled material. The model 1117-b-2 further includes a computer based model 1115-b representing the background material 815-a of FIG. 8 and configured in the same way.

In the model 1113-b of the porous material, the porous material includes a front surface 1120-b and a back surface 1160-b. The layer of porous material includes the material area of the layer and open areas 1125-b that extend through the layer from the front surface 1120-b to the back surface 1160-b.

In the model 1117-b-2, the model 1111-b of the artwork is represented as printed on the front surface of the model 1115-b of the background material and the model 1115-b of the background material is represented as disposed in back 1109-b of the model 1113-b of the porous material. In the model 1113-b of the porous material, the porous material is represented as unprinted.

In the embodiment of FIG. 11C, program instructions can execute to transform the computer based model 1117-b-2. This transforming includes compositing at least a portion of the model 1111-b of the artwork image with at least a portion of the model 1113-b of the porous material.

In FIG. 11C, this compositing includes modulating the model 1111-b of the artwork image with a masking function 1156-b. The masking function 1156-b applies to the model 1111-b at locations that are based on the material area of the layer of material 1113-c, because the material is opaque. In alternate embodiments, where the material area is not fully opaque an opacity function can be applied to model 1111-b instead of the masking function, at locations that are based on the material area.

When the masking function 1156-b is applied, program instructions can execute such that the portions of the artwork image that correspond with the locations of the material are not displayed when the model 1117-b-2 represents the front appearance of the composited printed material.

In various embodiments, the model 1117-b-2 can be alternatively configured with any alternate embodiment of artwork, and/or any alternate embodiment of fibrous material, and/or any alternate embodiment of background material, as described herein or as known in the art, in any combination, and program instructions can execute to transform such alternate embodiments, to represent the appearance of a printed material, as described herein.

FIG. 11D is an illustration 1117-c-2 of a front appearance of the composited printed material of FIG. 11C, as displayed by the computer based model 1117-b-2. The illustration 1117-c-2 displays the material area of the layer of material 1113-c and portions of the background material 1115-c that are not obstructed by the layer of material 1113-c.

In FIG. 11D, portions of the artwork image are displayed. This represents the printing of the artwork image on the front of the background material 1115-c. The portions of the artwork image that correspond with the locations of the material area are not displayed. This represents the portions of the artwork image that are obstructed by the material area.

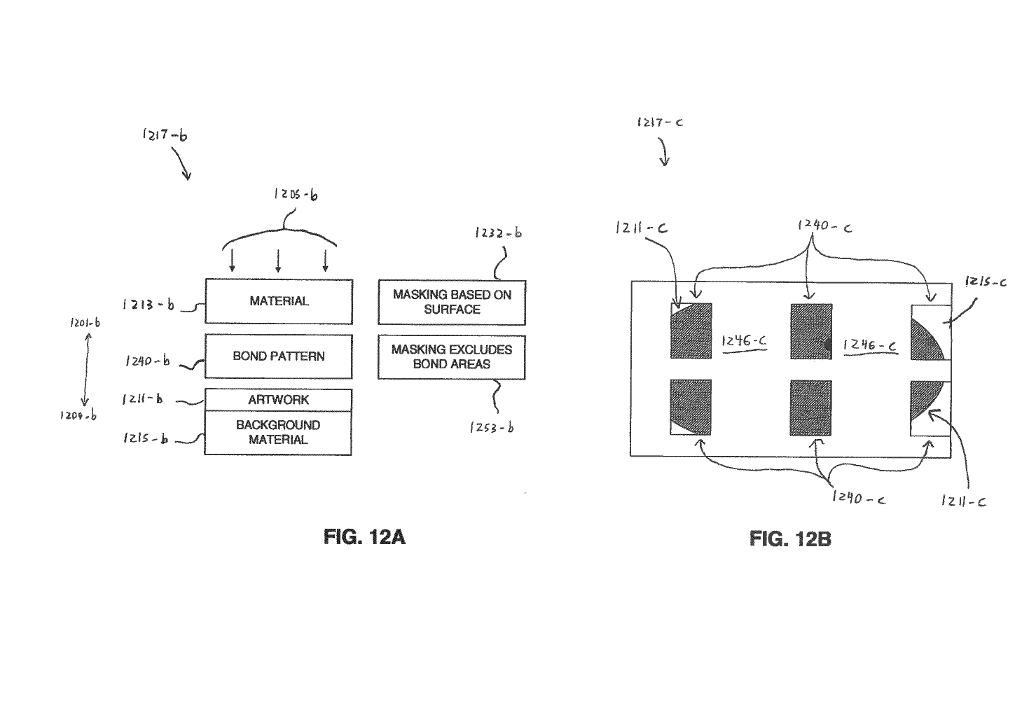

FIG. 12A is a block diagram of a computer based model 1217-b of a printed material having an artwork image printed on a front surface of a background material that is disposed in back of a bonded material.

The model 1217-b includes a front direction 1201-b and a back direction 1209-b. In the model 1217-b, a representation of a front appearance of the printed material is created from viewing direction 1205-b, which is located in front 1201-b of the printed material and directed toward the back 1209-b.

The model 1217-b includes a computer based model 1211-b representing the artwork image 111-a of FIG. 1 and configured in the same way. The model 1217-b also includes a computer based model 1213-b representing the layer of bonded material 513-a of FIG. 5, with elements of the model configured in the same way as like-numbered elements of the modeled material. The model 1217-b further includes a computer based model 1215-b representing the background material 815-a of FIG. 8 configured in the same way.

In the model 1217-b, the model 1211-b of the artwork is represented as printed on the front surface of the model 1215-b of the background material and the model 1215-b of the background material is represented as disposed in back 1209-b of the model 1213-b of the bonded material.

In the model 1213-b of the bonded material, the bonded material is a material that includes bond areas 1243-b and an unbonded area 1246-b. In the model 1213-b of the bonded material, the bonded material is represented as unprinted.

In the embodiment of FIG. 12A, program instructions can execute to transform the computer based model 1217-b. This transforming includes compositing at least a portion of the model 1211-b of the artwork image with at least a portion of the model 1213-b of the bonded material.

In FIG. 12A, this compositing includes modulating the model 1211-b of the artwork image with a masking function 1232-b. The masking function 1232-b applies to the model 1211-b at locations that are based on the unbonded area 1246-b, since the unbonded area 1246-a is fully opaque. When the masking function 1232-b is applied, program instructions can execute such that the portions of the artwork image that correspond with the locations of the unbonded areas 1246-b are not displayed when the model 1217-b represents the front appearance of the composited printed material.

In FIG. 12A, the modulating of the model 1211-b of the artwork image with the masking function 1232-b excludes 1253-b the bond areas, since the bond areas are fully transparent. When the masking function 1232-b is excluded for the bond areas, program instructions can execute such that the masking function is turned off (i.e. rendered ineffective) for the bond areas. In alternate embodiments, where the bond areas have a non-zero opacity, an opacity function can also be applied to the model 1211-b of the artwork image at locations that are based on the bond areas.

In various embodiments, the model 1217-b can be alternatively configured with any alternate embodiment of artwork, and/or any alternate embodiment of bonded material, and/or any alternate embodiment of background material, as described herein or as known in the art, in any combination, and program instructions can execute to transform such alternate embodiments, to represent the appearance of a printed material, as described herein.

FIG. 12B is an illustration 1217-c of a front appearance of the composited printed material of FIG. 12A, as displayed by the computer based model 1217-b. The illustration 1217-c displays the bond areas 1243-c and the unbonded areas 1246-c of the bonded material 1213-c.

In FIG. 12B, portions of the artwork image are displayed. This represents the printing of the artwork image on the front of the background material 1215-c. The portions of the artwork image that correspond with the locations of the bonded areas 1243-c are displayed. This represents the portions of the artwork image that are visible through the fully transparent bonded areas 1243-c. The portions of the artwork image that do not correspond with the locations of the bonded areas 1243-c are not displayed. This represents the portions of the artwork image that are obstructed by the fully opaque unbonded area 1246-c.

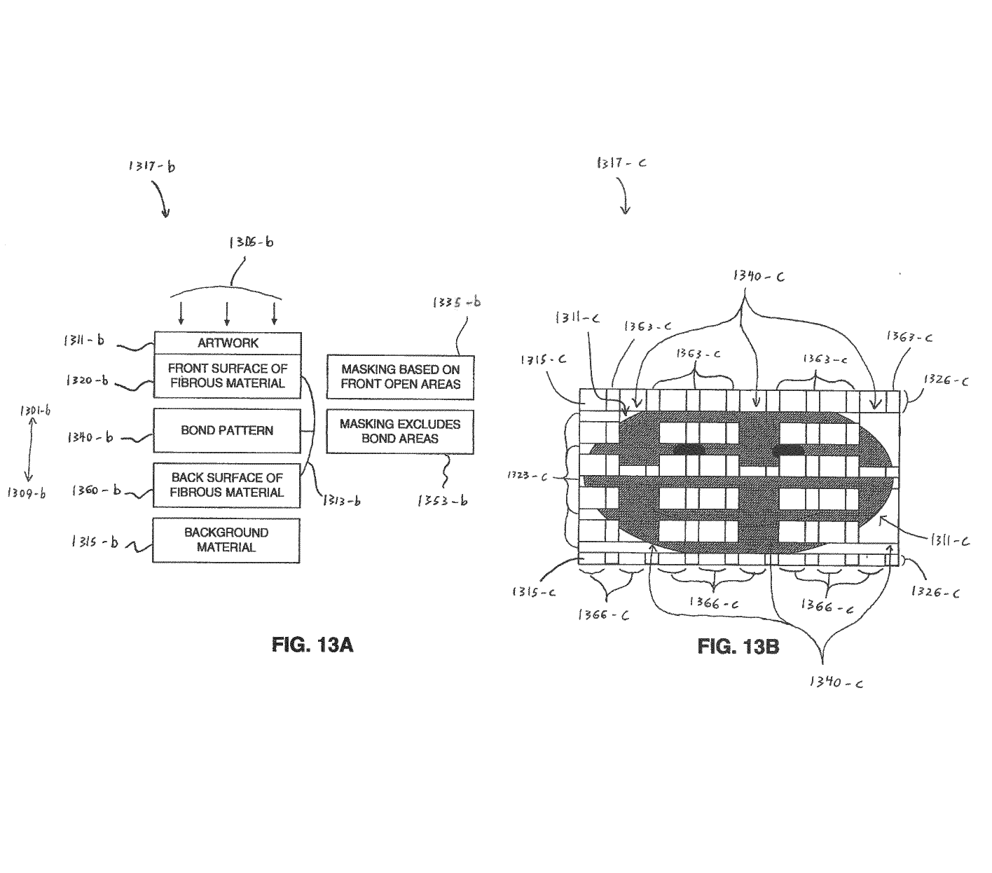

FIG. 13A is a block diagram of a computer based model 1317-b of a printed material having an artwork image printed on a front surface of a layer of bonded fibrous material and an unprinted background material that is disposed in back of the bonded fibrous material.

The model 1317-b includes a front direction 1301-b and a back direction 1309-b. In the model 1317-b, a representation of a front appearance of the printed material is created from viewing direction 1305-b, which is located in front 1301-b of the printed material and directed toward the back 1309-b.

The model 1317-b includes a computer based model 1311-b representing the artwork image 111-a of FIG. 1 and configured in the same way. The model 1317-b also includes a computer based model 1313-b representing the layer of bonded fibrous material 713-a of FIG. 7, with elements of the model configured in the same way as like-numbered elements of the modeled material. The model 1317-b further includes a computer based model 1315-b representing the background material 815-a of FIG. 8 and configured in the same way.

In the model 1313-b of the bonded fibrous material, the bonded fibrous material is a material that includes a front surface 1320-b, a bond pattern 1340-b, and a back surface 1360-b. The front surface 1320-b includes front fibers 1323-b and front open areas 1326-b. The back surface 1360-b includes back fibers 1363-b and back open areas 1366-b. In the model 1313-b of the bonded fibrous material, the bonded fibrous material is a material that includes bond areas 1343-b and an unbonded area 1346-b.

In the model 1317-b, the model 1311-b of the artwork is represented as printed on the front surface 1320-b of the model 1313-b of the bonded fibrous material and the model 1315-b of the background material is represented as disposed in back 1309-b of the model 1313-b of the bonded fibrous material. In the model 1315-b of the background material, the background material is represented as unprinted.

In the embodiment of FIG. 13A, program instructions can execute to transform the computer based model 1317-b. This transforming includes compositing at least a portion of the model 1311-b of the artwork image with at least a portion of the model 1313-b of the bonded fibrous material.

In FIG. 13A, this compositing includes modulating the model 1311-b of the artwork image with a masking function 1335-b. The masking function 1335-b applies to the model 1311-b at locations that are based on the front open areas 1326-b, because the front open areas 1326-b cannot be printed with the artwork image. When the masking function 1335-b is applied, program instructions can execute such that the portions of the artwork image that correspond with the locations of the front open areas 1326-b are not displayed when the model 1317-b represents the front appearance of the composited printed material. In FIG. 13A, the modulating of the model 1311-b of the artwork image with the masking function 1335-b excludes 1353-b the bond areas, since the bond areas are fully transparent. When the masking function 1335-b is excluded for the bond areas, program instructions can execute such that the masking function is turned off (i.e. rendered ineffective) for the bond areas. In alternate embodiments, where the bond areas have a non-zero opacity, an opacity function can also be applied to the model 1311-b of the artwork image at locations that are based on the bond areas.

In various embodiments, the model 1317-b can be alternatively configured with any alternate embodiment of artwork, and/or any alternate embodiment of bonded fibrous material, and/or any alternate embodiment of background material, as described herein or as known in the art, in any combination, and program instructions can execute to transform such alternate embodiments, to represent the appearance of a printed material, as described herein.

FIG. 13B is an illustration 1317-c of a front appearance of the composited printed material of FIG. 13A, as displayed by the computer based model 1317-b. The illustration 1317-c displays the front fibers 1323-c, portions of the back fibers 1326-c that are not obstructed by the front fibers 1323-c, the bond areas 1343-c, and portions of the background material 1315-c that are not obstructed by the front fibers 1323-c and/or the back fibers 1326-c.

In FIG. 13B, portions of the artwork image are displayed. This represents the printing of the artwork image on the front of the fibrous bonded material 1313-c. The portions of the artwork image that correspond with the locations of the front fibers 1323-c are displayed. This represents the printing of the artwork image on the front fibers 1323-c. The portions of the artwork image that correspond with the locations of the bond areas 1343-c are displayed. This represents the printing of the artwork image on the front of the bond areas 1343-c. The portions of the artwork image that do not correspond with the locations of the front fibers 1323-c and that do not correspond with the locations of the bond areas 1343-c are not displayed. This represents the absence of printing outside of the front fibers 1323-c and the bond areas 1343-c.

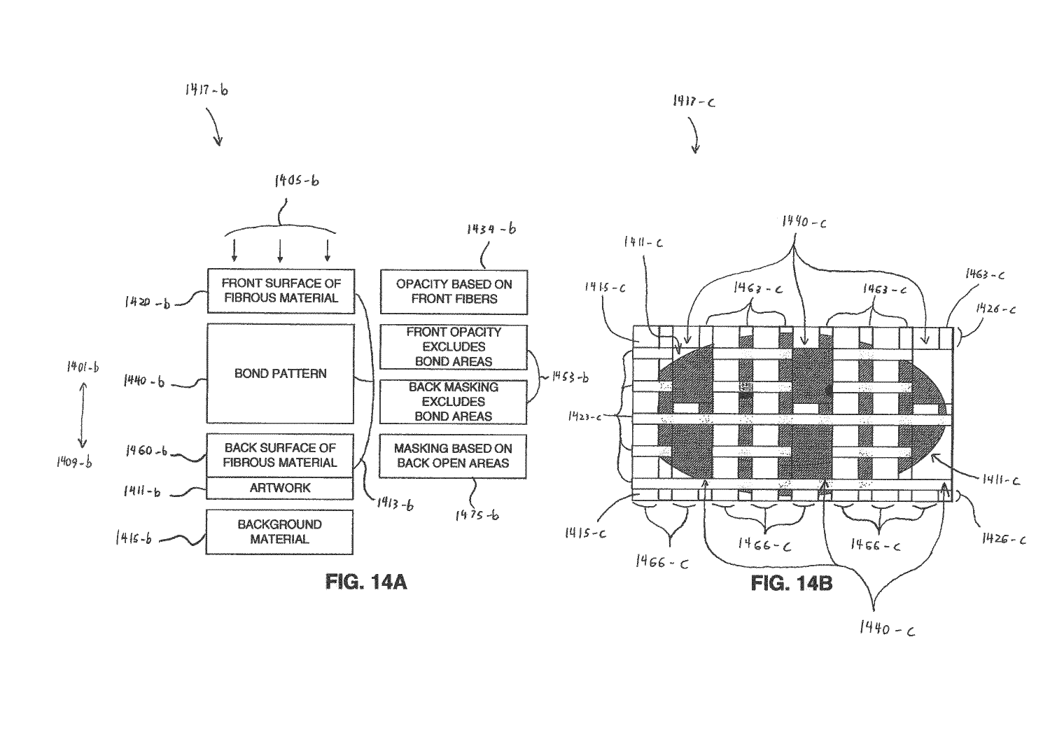

FIG. 14A is a block diagram of a computer based model 1417-b of a printed material having an artwork image printed on a back surface of a layer of bonded fibrous material and an unprinted background material that is disposed in back of the bonded fibrous material.

The model 1417-b includes a front direction 1401-b and a back direction 1409-b. In the model 1417-b, a representation of a front appearance of the printed material is created from viewing direction 1405-b, which is located in front 1401-b of the printed material and directed toward the back 1409-b.

The model 1417-b includes a computer based model 1411-b representing the artwork image 111-a of FIG. 1 and configured in the same way. The model 1417-b also includes a computer based model 1413-b representing the layer of bonded fibrous material 713-a of FIG. 7, with elements of the model configured in the same way as like-numbered elements of the modeled material. The model 1417-b further includes a computer based model 1415-b representing the background material 815-a of FIG. 8 configured in the same way.

In the model 1413-b of the bonded fibrous material, the bonded fibrous material is a material that includes a front surface 1420-b and a back surface 1460-b. The front surface 1420-b includes front fibers 1423-b and front open areas 1426-b. The back surface 1460-b includes back fibers 1463-b and back open areas 1466-b. In the model 1413-b of the bonded fibrous material, the bonded fibrous material is a material that includes bond areas 1443-b and an unbonded area 1446-b.

In the model 1417-b, the model 1411-b of the artwork is represented as printed on the back surface 1460-b of the model 1413-b of the bonded fibrous material and the model 1415-b of the background material is represented as disposed in back 1409-b of the model 1413-b of the bonded fibrous material. In the model 1415-b of the background material, the background material is represented as unprinted.

In the embodiment of FIG. 14A, program instructions can execute to transform the computer based model 1417-b. This transforming includes compositing at least a portion of the model 1411-b of the artwork image with at least a portion of the model 1413-b of the bonded fibrous material.

In FIG. 14A, this compositing includes modulating the model 1411-b of the artwork image with a masking function 1475-b. The masking function 1475-b applies to the model 1411-b at locations that are based on the back open areas 1466-b, because the back open areas 1466-b cannot be printed with the artwork image. When the masking function 1475-b is applied, program instructions can execute such that the portions of the artwork image that correspond with the locations of the back open areas 1466-b are not displayed when the model 1417-b represents the front appearance of the composited printed material. In FIG. 14A, the modulating of the model 1411-b of the artwork image with the masking function 1475-b excludes 1453-b the bond areas. When the masking function 1475-b is excluded for the bond areas, program instructions can execute such that the masking function is turned off (i.e. rendered ineffective) for the bond areas.

In FIG. 14A, the compositing also includes modulating the model 1411-b of the artwork image with an opacity function 1434-b. The opacity function 1434-b applies to the model 1411-b at locations that are based on the front fibers 1423-b. When the opacity function 1434-b is applied, program instructions can execute such that the portions of the artwork image that correspond with the locations of the front fibers 1423-b are displayed with reduced intensity when the model 1417-b represents the front appearance of the composited printed material. In FIG. 14A, the modulating of the model 1411-b of the artwork image with the opacity function 1434-b excludes 1453-b the bond areas, since the bond areas are fully transparent. When the opacity function 1434-b is excluded for the bond areas, program instructions can execute such that the opacity function is turned off (i.e. rendered ineffective) for the bond areas. In alternate embodiments, where the bond areas have a non-zero opacity, an opacity function can also be applied to model 1411-b at locations that are based on the bond areas.

In various embodiments, the model 1417-b can be alternatively configured with any alternate embodiment of artwork, and/or any alternate embodiment of bonded fibrous material, and/or any alternate embodiment of background material, as described herein or as known in the art, in any combination, and program instructions can execute to transform such alternate embodiments, to represent the appearance of a printed material, as described herein.

FIG. 14B is an illustration 1417-c of a front appearance of the composited printed material of FIG. 14A, as displayed by the computer based model 1417-b. The illustration 1417-c displays the front fibers 1423-c, portions of the back fibers 1426-c that are not obstructed by the front fibers 1423-c, bond areas 1443-c, and portions of the background material 1415-c that are not obstructed by the front fibers 1423-c and/or the back fibers 1426-c.

In FIG. 14B, portions of the artwork image are displayed. This represents the printing of the artwork image on the back of the fibrous bonded material 1413-c. The portions of the artwork image that correspond with the locations of the back fibers 1463-c are displayed. This represents the printing of the artwork image on the back fibers 1463-c. The portions of the artwork image that correspond with both the locations of the back fibers 1463-c and the locations of the front fibers 1423-c are displayed with reduced intensity. This represents the opacity of the front fibers 1423-c. The portions of the artwork image that correspond with the locations of the back fibers 1463-c but do not correspond with the locations of the front fibers 1423-c are displayed without reduced intensity. This represents the absence of the opacity of the front fibers 1423-c.

The portions of the artwork image that correspond with the locations of the bond areas 1443-c are also displayed. This represents the printing of the artwork image on the back of the bond areas 1443-c.

The portions of the artwork image that do not correspond with the locations of the back fibers 1463-c and that do not correspond with the locations of the bond areas 1443-c are not displayed. This represents the absence of printing outside of the back fibers 1463-c and the bond areas 1443-c.

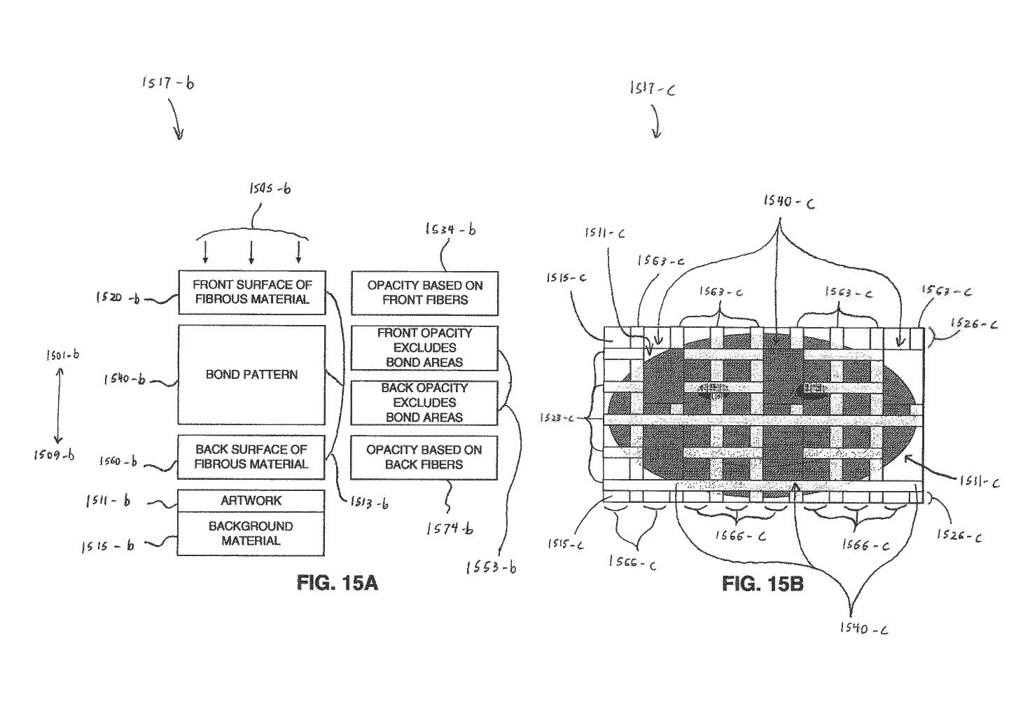

FIG. 15A is a block diagram of a computer based model 1517-b of a printed material having an artwork image printed on a front surface of a background material that is disposed in back of a bonded fibrous material.

The model 1517-b includes a front direction 1501-b and a back direction 1509-b. In the model 1517-b, a representation of a front appearance of the printed material is created from viewing direction 1505-b, which is located in front 1501-b of the printed material and directed toward the back 1509-b.

The model 1517-b includes a computer based model 1511-b representing the artwork image 111-a of FIG. 1 and configured in the same way. The model 1517-b also includes a computer based model 1513-b representing the layer of bonded fibrous material 713-a of FIG. 7, with elements of the model configured in the same way as like-numbered elements of the modeled material. The model 1517-b further includes a computer based model 1515-b representing the background material 815-a of FIG. 8 configured in the same way.

In the model 1513-b of the bonded fibrous material, the bonded fibrous material is a material that includes a front surface 1520-b and a back surface 1560-b. The front surface 1520-b includes front fibers 1523-b and front open areas 1526-b. The back surface 1560-b includes back fibers 1563-b and back open areas 1566-b. In the model 1513-b of the bonded fibrous material, the bonded fibrous material is a material that includes bond areas 1543-b and an unbonded area 1546-b.

In the model 1517-b, the model 1511-b of the artwork is represented as printed on the front surface of the model 1515-b of the background material and the model 1515-b of the background material is represented as disposed in back 1509-b of the model 1513-b of the bonded fibrous material.

In the embodiment of FIG. 15A, program instructions can execute to transform the computer based model 1517-b. This transforming includes compositing at least a portion of the model 1511-b of the artwork image with at least a portion of the model 1513-b of the bonded fibrous material.

In FIG. 15A, this compositing includes modulating the model 1511-b of the artwork image with an opacity function 1534-b. The opacity function 1534-b applies to the model 1511-b at locations that are based on the front fibers 1523-b. When the opacity function 1534-b is applied, program instructions can execute such that the portions of the artwork image that correspond with the locations of the front fibers 1523-b are displayed with reduced intensity when the model 1517-b represents the front appearance of the composited printed material. In FIG. 15A, the modulating of the model 1511-b of the artwork image with the opacity function 1534-b excludes 1553-b the bond areas, since the bond areas are fully transparent. When the opacity function 1534-b is excluded for the bond areas, program instructions can execute such that the masking function is turned off (i.e. rendered ineffective) for the bond areas. In alternate embodiments, where the bond areas have a non-zero opacity, an opacity function can also be applied to the model 1511-b of the artwork image at locations that are based on the bond areas.

In FIG. 15A, the compositing also includes modulating the model 1511-b of the artwork image with an opacity function 1574-b. The opacity function 1574-b applies to the model 1511-b at locations that are based on the back fibers 1563-b. When the opacity function 1574-b is applied, program instructions can execute such that the portions of the artwork image that correspond with the locations of the back fibers 1563-b are displayed with reduced intensity when the model 1517-b represents the front appearance of the composited printed material. In FIG. 15A, the modulating of the model 1511-b of the artwork image with the opacity function 1574-b excludes 1553-b the bond areas, since the bond areas are fully transparent. When the opacity function 1574-b is excluded for the bond areas, program instructions can execute such that the opacity function is turned off (i.e. rendered ineffective) for the bond areas.

In various embodiments, the model 1517-b can be alternatively configured with any alternate embodiment of artwork, and/or any alternate embodiment of bonded fibrous material, and/or any alternate embodiment of background material, as described herein or as known in the art, in any combination, and program instructions can execute to transform such alternate embodiments, to represent the appearance of a printed material, as described herein.

FIG. 15B is an illustration 1517-c of a front appearance of the composited printed material of FIG. 15A, as displayed by the computer based model 1517-b. The illustration 1517-c displays the front fibers 1523-c, portions of the back fibers 1526-c that are not obstructed by the front fibers 1523-c, bond areas 1543-c, and portions of the background material 1515-c that are not obstructed by the front fibers 1523-c and/or the back fibers 1526-c.

In FIG. 15B, portions of the artwork image are displayed. This represents the printing of the artwork image on the front of the background material 1515-c. The portions of the artwork image that correspond with the locations of the front fibers 1523-c are displayed with reduced intensity. This represents the opacity of the front fibers 1523-c. The portions of the artwork image that correspond with the locations of the back fibers 1563-c are also displayed with reduced intensity. This represents the opacity of the back fibers 1563-c. The portions of the artwork image that correspond with both the locations of the front fibers 1523-c and the locations of the back fibers 1563-c are displayed with greatly reduced intensity. This represents the combined opacity of the front fibers 1523-c and the back fiber 1563-c.

The portions of the artwork image that correspond with the locations of the bonded areas 1543-c are displayed. This represents the portions of the artwork image that are visible through the fully transparent bonded areas 1543-c.

The portions of the artwork image that do not correspond with the locations of the front fibers 1523-c and that do not correspond with the locations of the back fibers 1563-c are displayed without reduced intensity. This represents the absence of the opacity of the front fibers 1523-c and the absence of the opacity of the back fibers 1563-c.

It is also contemplated that, in various embodiments, part, parts, or all of any of the models described herein can be combined with part, parts, or all of any number of any of the other models described herein and/or with part, parts, or all of any number of any other model for printed material that is known in the art. Further, part, parts, or all of any number of any of the models described herein, including any of the combinations mentioned above, along with any variations described herein and/or known in art, can be superimposed upon each other, to create additional embodiments for computer based models, which can be used in methods of representing an artwork image on a printed material.

As described above, embodiments of the present disclosure can at least assist in predicting how a particular artwork image will appear when it is printed on a particular material. The present disclosure includes methods of representing an artwork image with a computer based model of the artwork image. In particular, the present disclosure includes computer based methods for simulating the appearance of materials printed with artwork images. As a result, materials that are printed with artwork images can be evaluated and modified as computer based models before they are printed in the real world.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of simulating the appearance of a printed material, comprising:
representing a layer of textured material with a computer based model of the layer of textured material;
representing an artwork image with a computer based model of the artwork image;
transforming the computer based model of the artwork image by compositing at least a portion of the computer based model of the artwork image with at least a portion of the computer based model of the layer of textured material to form a computer based model of a composited printed material; and
representing a front appearance of the composited printed material with the computer based model of the composited printed material.

2. The method of claim 1, wherein the layer of textured material is a layer of fibrous material.

3. The method of claim 2, wherein the layer of textured material is a layer of nonwoven material.

4. A method of simulating the appearance of a printed material, comprising:
representing a layer of fibrous material with a computer based model of the layer of fibrous material;
representing an artwork image with a computer based model of the artwork image;
transforming the computer based model of the artwork image by compositing at least a portion of the computer based model of the artwork image with at least a portion of the computer based model of the layer of fibrous material to form a computer based model of a composited printed material; and
representing a front appearance of the composited printed material with the computer based model of the composited printed material;
wherein:
the layer of fibrous material has a major surface with a plurality of open areas; and
the compositing includes modulating a front appearance of a portion of the artwork image with a masking function applied to locations based on the plurality of open areas to form the composited printed material.

5. The method of claim 4, wherein:
the major surface is a front major surface with a plurality of front fibers; and
the representing of the artwork image includes representing the artwork image with a computer based model of the artwork image, wherein at least a portion of the artwork image is disposed on the plurality of front fibers.

6. The method of claim 5, wherein:
the layer of fibrous material includes a plurality of bond areas; and
the representing of the artwork image includes representing the artwork image with a computer based model of the artwork image, wherein at least a portion of the artwork image is disposed on the plurality of bond areas.

7. The method of claim 6, wherein the compositing includes modulating a front appearance of a portion of the artwork image with the masking function, wherein the masking function excludes locations based on the plurality bond areas.

8. A method of simulating the appearance of a printed material, comprising:
representing a layer of fibrous material with a computer based model of the layer of fibrous material;
representing an artwork image with a computer based model of the artwork image;
transforming the computer based model of the artwork image by compositing at least a portion of the computer based model of the artwork image with at least a portion of the computer based model of the layer of fibrous material to form a computer based model of a composited printed material; and
representing a front appearance of the composited printed material with the computer based model of the composited printed material;
wherein:
the layer of fibrous material has a major surface with a plurality of fibers; and
the compositing includes modulating a front appearance of a portion of the artwork image with an opacity function applied to locations based on the plurality of fibers to form the composited printed material.

9. The method of claim 8, wherein the major surface is a front major surface and the plurality of fibers is a plurality of front fibers.

10. The method of claim 9, wherein:
the layer of fibrous material has a back major surface with a plurality of back fibers; and
the representing of the artwork image includes representing the artwork image with a computer based model of the artwork image, wherein at least a portion of the artwork image is disposed on the plurality of back fibers.

11. The method of claim 10, wherein:
the back major surface has a plurality of back open areas; and
the compositing includes modulating a front appearance of a portion of the artwork image with a masking function applied to locations based on the plurality of back open areas to form the composited printed material.

12. The method of claim 11, wherein:
the layer of fibrous material includes a plurality of bond areas; and
the representing of the artwork image includes representing the artwork image with a computer based model of the artwork image, wherein at least a portion of the artwork image is disposed on the plurality of bond areas.

13. The method of claim 12, wherein the compositing includes modulating a front appearance of a portion of the artwork image with the masking function, wherein the masking function excludes locations based on the plurality bond areas.

14. The method of claim 9 including representing a layer of background material with a computer based model of the layer of background material, wherein the representing of the artwork image includes representing the artwork image with a computer based model of the artwork image, wherein at least a portion of the artwork image is disposed on at least a portion of the background material.

15. The method of claim 14, wherein the layer of background material is a layer of film material.

16. The method of claim 14, wherein:
the layer of fibrous material has a back major surface with a plurality of back fibers; and
the compositing includes modulating a front appearance of a portion of the artwork image with an opacity function applied to locations based on the plurality of back fibers to form the composited printed material.

17. The method of claim 16, wherein:
the layer of fibrous material includes a plurality of bond areas; and
the opacity function that is based on the front fibers excludes locations based on the plurality bond areas.

18. The method of claim 16, wherein:
the layer of fibrous material includes a plurality of bond areas; and
the opacity function that is based on the back fibers excludes locations based on the plurality bond areas.

19. A computer readable medium having instructions for causing a device to perform a method of simulating the appearance of a printed material, the method comprising:
representing a layer of fibrous material with a computer based model of the layer of fibrous material;
representing an artwork image with a computer based model of the artwork image;
transforming the computer based model of the artwork image by compositing at least a portion of the computer based model of the artwork image with at least a portion of the computer based model of the layer of fibrous material to form a computer based model of a composited printed material; and
representing a front appearance of the composited printed material with the computer based model of the composited printed material.

20. The computer readable medium of claim 19, where, in the method:
the layer of fibrous material has a front major surface with a plurality of front fibers and a plurality of front open areas;
the compositing includes modulating a front appearance of a portion of the artwork image with a masking function applied to locations based on the plurality of front open areas to form the composited printed material; and
the representing of the artwork image includes representing the artwork image with a computer based model of the artwork image, wherein at least a portion of the artwork image is disposed on the plurality of front fibers.

21. The computer readable medium of claim 19, where, in the method:
the layer of fibrous material has a front major surface with a plurality of front fibers and a plurality of front open areas, as well as a back major surface with a plurality of back fibers and a plurality of back open areas;
the representing of the artwork image includes representing the artwork image with a computer based model of the artwork image, wherein at least a portion of the artwork image is disposed on the plurality of back fibers;
the compositing includes modulating a front appearance of a portion of the artwork image with an opacity function applied to locations based on the plurality of front fibers to form the composited printed material; and
the compositing also includes modulating a front appearance of a portion of the artwork image with a masking function applied to locations based on the plurality of back open areas to form the composited printed material.

22. The computer readable medium of claim 19, where the method includes representing a layer of background material with a computer based model of the layer of background material, and where, in the method:
the layer of fibrous material has a front major surface with a plurality of front fibers and a plurality of front open areas, as well as a back major surface with a plurality of back fibers and a plurality of back open areas;
the representing of the artwork image includes representing the artwork image with a computer based model of the artwork image, wherein at least a portion of the artwork image is disposed on at least a portion of the background material;
the compositing includes modulating a front appearance of a portion of the artwork image with an opacity function applied to locations based on the plurality of fibers to form the composited printed material; and
the compositing includes modulating a front appearance of a portion of the artwork image with an opacity function applied to locations based on the plurality of back fibers to form the composited printed material.
